(19) United States
(12) Patent Application Publication
(10) Pub. No.: US 2010/0047456 A1
(43) Pub. Date: Feb. 25, 2010

(54) INK-JET RECORDING METHOD

(75) Inventor: Toshihiro KARIYA, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/498,373

(22) Filed: Jul. 7, 2009

(30) Foreign Application Priority Data
Aug. 21, 2008 (JP) 2008-213254

(51) Int. Cl. B05D 1/36; B05D 5/00

(52) U.S. Cl. 427/265

(57) ABSTRACT

An ink-jet recording method is provided. The method includes recording an image by ejecting, using an ink-jet method, an aqueous ink containing a colorant, resin particles, a water-soluble organic solvent and water onto a coated paper having a Ka value with respect to water, which is obtained by measuring liquid absorbability according to the Bristow method, of from 0.1 ml·m⁻²·msec^{-1/2} to 0.3 ml·m⁻²·msec^{-1/2}; and supplying, onto the coated paper, an aqueous treatment liquid containing a fixing agent for fixing the components contained in the aqueous ink, and a water-soluble organic solvent which is contained in an amount of 70% by mass or more relative to the total amount of water-soluble organic solvents contained in the aqueous treatment liquid, and has an SP value of 27.5 or less and a boiling point at 101.3 kPa of from 230° C. to 280° C.

### CROSS-REFERENCE TO RELATED APPLICATION

This Application claims priority under 35 USC 119 from Japanese Patent Application No. 2008-213254 filed on Aug. 21, 2008, the disclosure of which is incorporated by reference herein.

### BACKGROUND OF THE INVENTION

1. Technical Field

The present invention relates to an ink-jet recording method.

2. Description of the Related Art

Various methods have been proposed for image recording methods for recording color images in recent years. However, in all of these methods, there are still demands on the quality levels of recorded objects, for example, in relation to quality of image, texture, and curling properties after recording.

Among these methods, the ink-jet technique has been applied for office printers and household printers, and is recently increasingly being applied in the field of commercial printing. In the commercial printing field, printed sheets are required to have an appearance similar to that of general printing paper, rather than a surface that completely blocks penetration of ink solvent into the base paper such as that of a photograph. However, when a solvent absorption layer of a recording medium has a thickness from 20 μm to 30 μm, the ranges of properties such as surface gloss, texture and stiffness are limited. Therefore, the application of ink-jet techniques in commercial printing has been limited to, for example, posters and forms, for which restrictions on surface gloss, texture, stiffness and the like are tolerable. Furthermore, a recording medium for exclusive use in ink-jet recording is expensive since it is provided with a solvent absorbing layer and a water resistant layer, and this is also a factor that limits the application of ink-jet technology in the field of commercial printing.

As an ink-jet recording method for forming high quality images, a number of image recording methods in which a liquid composition for improving images is used in addition to an usual ink-jet ink, and the liquid composition is deposited on a recording medium prior to jetting of ink for recording, have been proposed (see, for example, Japanese Patent Application Laid-Open (JP-A) Nos. 9-207424 and 2006-188045). In these methods, the components of the ink-jet recording liquid are aggregated on the surface of paper, and thus the components are fixed before dullness or bleeding occurs.

Furthermore, a method for forming an image in which the liquid composition includes an organic solvent which exhibits a specific vapor pressure (see, for example, JP-A No. 2006-159422) and a method for forming an image in which the penetration coefficient of the liquid composition according to the Bristow method is in a specific range (see, for example, JP-A No. 2004-130792 and JP-A No. 2007-152808) have been suggested.

### SUMMARY OF THE INVENTION

However, since the methods for forming an image described in JP-A No. 9-207424 and JP-A No. 2006-188045 involve a recording process in which a reaction liquid is supplied onto the surface of a recording medium, and then a pigment ink is supplied on the recording medium such that the pigment ink is mixed with the reaction liquid on the print medium in a liquid state, deterioration of the fixability of images, and significant paper deformation such as curling or cockling of the recording medium have sometimes occurred, which problems do not occur when images are formed using a pigment ink alone. Further, when such paper deformation occurs, a paper jam may be caused, or ink spotting positions may be displaced, which may reduce image quality, or the recording surface may be brought to contact with the ink-jet head and stained.

Generally, in the methods for forming an image by printing on a coated paper with ink, the abrasion resistance of the image is poor, and the abrasion resistance is particularly poor and is problematic with a coated paper having a low solvent penetration speed such that the Ka value with respect to water, which is obtained by measuring the liquid absorbability according to the Bristow method, is 0.1 ml·m⁻²·msec^{-1/2} or more and 0.3 ml·m⁻²·msec^{-1/2} or less.

Furthermore, when using such a coated paper having a low solvent penetration speed, a problem arises whereby an increase in the difference between the size of a dot formed by printing a dot of a second color on a solid image of a first color often occurs, and the size of a dot formed by printing a dot of a second color alone, and this increase may influence the resolution, although high resolution is required in the field of commercial printing. However, it is difficult to control this difference by means of the amount of the liquid composition or the ink supplied.

The invention has been made in view of such circumstances, and provides an ink-jet recording method.

According to an aspect of the present invention, an ink-jet recording method is provided. The ink-jet recording method of an aspect of the invention includes recording an image by ejecting, using an ink-jet method, an aqueous ink containing a colorant, resin particles, a water-soluble organic solvent and water onto a coated paper having a Ka value with respect to water, which is obtained by measuring liquid absorbability according to the Bristow method, of from 0.1 ml·m⁻²·msec^{-1/2} to 0.3 ml·m⁻²·msec^{-1/2}; and supplying, onto the coated paper, an aqueous treatment liquid containing a fixing agent for fixing the components contained in the aqueous ink, and a water-soluble organic solvent which is contained in an amount of 70% by mass or more relative to the total amount of water-soluble organic solvents contained in the aqueous treatment liquid, and has an SP value of 27.5 or less and a boiling point at 101.3 kPa of from 230° C. to 280° C.

### DETAILED DESCRIPTION OF THE INVENTION

The ink-jet recording method of the present invention includes recording an image by ejecting, using an ink-jet method, an aqueous ink containing a colorant, resin particles, a water-soluble organic solvent and water onto a coated paper having a Ka value with respect to water, which is obtained by measuring liquid absorbability according to the Bristow method, of from 0.1 ml·m⁻²·msec^{-1/2} to 0.3 ml·m⁻²·msec^{-1/2} (image recording step); and supplying, onto the coated paper, an aqueous treatment liquid containing a fixing agent for fixing the components contained in the aqueous ink, and a water-soluble organic solvent which is contained in an amount of 70% by mass or more relative to the total amount of water-soluble organic solvents contained in the aqueous treatment liquid, and has an SP value of 27.5 or less and a boiling point at 101.3 kPa of from 230° C. to 280° C. (treatment liquid supplying step).

When an aqueous treatment liquid containing a specific water-soluble organic solvent is used, even when using a coated paper having a low solvent penetration speed, it is possible to carry out an ink-jet recording method by which the obtained image may be favorable, the fluctuation in the size of a second color dot may be small, and the occurrence of curling may be suppressed.

Hereinafter, the aqueous treatment liquid, coated paper and aqueous ink used in the invention will be described, and subsequently, the ink-jet recording method will be described.

<Aqueous Treatment Liquid>

The aqueous treatment liquid according to the invention contains at least one fixing agent for fixing the components of the aqueous ink that will be described later, and at least one water-soluble organic solvent having an SP value of 27.5 or less and a boiling point at 101.3 kPa (760 mmHg) of from 230° C. to 280° C. (hereinafter, may also be referred to as “specific water-soluble organic solvent”), and the amount of the specific water-soluble organic solvent(s) contained in the aqueous treatment liquid relative to the total amount of water-soluble organic solvents contained in the aqueous treatment liquid is 70% by mass or more.

When an aqueous treatment liquid having such constitution is used, even when using a coated paper having a low solvent penetration speed as a recording medium, it is possible to perform ink-jet image recording by which the occurrence of curling may be suppressed, good abrasion resistance may be exhibited, the fluctuation in the diameter of the second color dot may be small, and excellent resolution may be obtained.

The SP value of the specific water-soluble organic solvent according to the invention is 27.5 or less. From the viewpoint of suppressing curling, the SP value is preferably 23.0 or less.

If the SP value exceeds 27.5, suppression of curling may be unsatisfactorily achieved. Also, the fluctuation in the diameter of the dot of second color is increased, so that the resolution may be decreased.

The term SP value (solubility parameter) of the water-soluble organic solvent as used in the invention refers to a value represented by a square root of the molecular cohesive energy, and this value is a value obtained at 25° C. and the unit thereof is (MPa)^{1/2}. The SP value can be calculated by the method described in R. F. Fedors, Polymer Engineering Science, 14, p. 147 to 154 (1974), the disclosure of which is incorporated by reference herein, and the SP value obtained accordingly is employed in the invention.

The boiling point at 101.3 kPa (760 mmHg) of the specific water-soluble organic solvent according to the invention is from 230° C. to 280° C.

If a water-soluble organic solvent having a boiling point of lower than 230° C. is used, water retention and wettability of the aqueous treatment liquid may be insufficiently obtained, and the storage stability may be decreased. Furthermore, with a water-soluble organic solvent having a boiling point of lower than 230° C., acceleration of the fixation of the components in the aqueous ink may be insufficiently achieved, and images of high image quality may not be obtained. On the other hand, if the boiling point of the water-soluble organic solvent is higher than 280° C., the drying properties of the aqueous ink may be affected, and the abrasion resistance may be deteriorated.

In the following, examples of water-soluble organic solvents having an SP value of 27.5 or less and a boiling point of from 230 to 280° C. will be presented, together with their SP values and boiling points (within the parentheses). However, the invention is not intended to be limited to the following examples.

Diethylene glycol monobutyl ether (SP value 21.5, boiling point 231° C.)

Triethylene glycol monomethyl ether (SP value 23.4, boiling point 245° C.)

Triethylene glycol monoethyl ether (SP value 21.7, boiling point 255° C.)

Triethylene glycol monobutyl ether (SP value 21.1, boiling point 278° C.)

Dipropylene glycol (SP value 27.2, boiling point 232° C.)

Tripropylene glycol monomethyl ether (SP value 20.4, boiling point 243° C.)

Triethyelne glycol monomethyl ether (SP value 22.1, boiling point 245° C.)

Tripropylene glycol (SP value 24.7, boiling point 273° C.)

The aqueous treatment liquid according to the invention may also contain other water-soluble organic solvents in addition to the specific water-soluble organic solvent, but the amount of the specific water-soluble organic solvent contained in the aqueous treatment liquid relative to the total amount of water-soluble organic solvents contained in the aqueous treatment liquid is 70% by mass or more. According to the invention, the amount of the specific water-soluble organic solvent contained in the treatment liquid relative to the total amount of water-soluble organic solvents contained in the treatment liquid is preferably 80% by mass or more, and more preferably 90% by mass or more. If the amount of the specific water-soluble organic solvent contained in the treatment liquid relative to the total amount of water-soluble organic solvents contained in the treatment liquid is less than 70% by mass, the curling suppressive effect may be unsatisfactory. Also, the fluctuation in the diameter of the dot of second color may be increased, and the resolution may be decreased.

Specific examples of the other water-soluble organic solvents are the same as the water-soluble organic solvents used in the aqueous ink that will be described later.

The total amount of the water-soluble organic solvents contained in the aqueous treatment liquid is preferably 30% by mass or less, and more preferably 5 to 25% by mass, relative to the treatment liquid, from the viewpoint of suppressing curling.

Also, it is preferable that the water-soluble organic solvent contained in the aqueous treatment liquid have a vapor pressure at 20° C. of less than 0.01 kPa, from the viewpoint of reducing volatile components.

Specific examples of the water-soluble organic solvent having a vapor pressure at 20° C. of less than 0.01 kPa, include diethylene glycol monobutyl ether (vapor pressure at 20° C.: <3.9 Pa), triethylene glycol monomethyl ether (vapor pressure at 20° C.: <1.33 Pa), triethylene glycol monobutyl ether (vapor pressure at 20° C.: <1.33 Pa), dipropylene glycol (vapor pressure at 20° C.: <1.33 Pa), and the like.

According to the invention, only one kind of water-soluble organic solvent may be used or two or more kinds of water-soluble organic solvent may be used as a mixture.

The aqueous treatment liquid according to the invention contains at least one fixing agent for fixing the components in the aqueous ink. The fixing agent is not particularly limited as long as it is capable of aggregating at least one of the components in the aqueous ink, but the fixing agent is preferably a compound capable of fixing (aggregating) the components in the aqueous ink by contacting with the aqueous ink in a state in which the compound is present within a dried film, and is more preferably a compound which easily dissolves in the aqueous ink by contacting with the aqueous ink.

Among them, from the viewpoint of aggregating properties, the fixing agent is preferably at least one selected from the group consisting of polyvalent metal salts having a high water-solubility and acidic substances having a high water solubility, and more preferably at least one selected from the group consisting of acidic substances having a high water solubility. It is even more preferable that these acidic substances be di- or higher valent acidic substances, in view of reacting with the ink composition and fixing the entire ink.

Here, the aggregation reaction of the aqueous ink may be achieved by decreasing the dispersion stability of the particles dispersed in the aqueous ink (colorants (for example, pigments), resin particles), and increasing the viscosity of the whole ink.

For example, when an acidic substance is used as the fixing agent, the dispersion stability may be decreased by reducing the surface charge of the particles in the ink, such as the pigments and resin particles, which have been stabilized in dispersion by means of weakly acidic functional groups such as a carboxyl group, by contacting with an acidic substance having a lower pKa value. Therefore, the acidic substance as the aggregating agent contained in the treatment liquid preferably has a low pKa value, has high solubility to water, and has a valency of two or greater. A divalent or trivalent acidic substance which has high buffering capability in a pH region lower than the pKa of the functional group (for example, a carboxyl group), which stabilizes the dispersion state of the particles in the ink, is more preferred.

Specific examples thereof include phosphoric acid, oxalic acid, malonic acid, succinic acid, citric acid, phthalic acid. Other acidic substances having a pKa and/or solubility that are similar to those of these acids may be used.

Among these acidic substances, citric acid has high water retaining power and has a tendency of resulting in high physical strength of the aggregated ink, and thus citric acid is preferably used in systems where more mechanical properties are demanded. On the other hand, malonic acid has low water retaining power, and is preferably used in the case where quick drying of the treatment liquid is desired.

As such, the fixing agent may also be appropriately selected for use on the basis of secondary factors, apart from the ability to fix the aqueous ink.

Examples of the polyvalent metal salts include salts of an alkaline earth metal of Group 2 in the Periodic Table (for example, magnesium and calcium), salts of a transition metal of Group 3 in the Periodic Table (for example, lanthanum), salts of a cation of the elements of Group 13 in the Periodic Table (for example, aluminum), and salts of a lanthanide (for example, neodymium). As for the salts of any of these metals, carboxylic acid salts (for example, formic acid salts, acetic acid salts, and benzoic acid salts), nitrates, chlorides, and thiocyanates are suitable. Among them, preferred are a calcium salt or magnesium salt of a carboxylic acid (for example, formic acid, acetic acid, or benzoic acid), calcium salt or magnesium salt of nitric acid, calcium chloride, magnesium chloride, and calcium salt or magnesium salt of thiocyanic acid.

The fixing agent may be used as one kind, or as a mixture of two or more kinds.

The content of the fixing agent(s) for fixing the components contained in the ink, in the aqueous treatment liquid is preferably in the range of 1 to 40% by mass, more preferably 5 to 30% by mass, and even more preferably 10 to 25% by mass.

The aqueous treatment liquid according to the present invention may contain, in general, in addition to the fixing agent a specific water-soluble organic solvent, a surfactant and various other additives. Details of the surfactant and the various other additives are similar to those for the aqueous ink that will be described later.

The surface tension of the aqueous treatment liquid according to the present invention is preferably 20 mN/m or more and 60 mN/m or less. More preferably, the surface tension is 25 mN/m or more and 50 mN/m or less, and is even more preferably 25 mN/m or more and 45 mN/m or less.

The viscosity at 20° C. of the aqueous treatment liquid in the invention is preferably 1.2 mPa·s or more and 15.0 mPa·s or less, more preferably 2 mPa·s or more and 12 mPa·s or less, and even more preferably 2 mPa·s or more and 8 mPa·s or less. When the viscosity of the aqueous treatment liquid is in the above described range, for example, when the aqueous treatment liquid is supplied by coating, the aqueous treatment liquid may be supplied more uniformly and stably. The viscosity of the aqueous treatment liquid can be measured using a viscometer (model name: TV-22, manufactured by Toki Sangyo Co., Ltd.).

The viscosity of the aqueous treatment liquid can be suitably changed by generally used method, such as adjusting the kind and content of a water-soluble organic solvent, addition of the viscosity adjusting agent, and the like.

<Coated Paper>

According to the present invention, as the recording medium, a coated paper having a Ka value with respect to water, which is obtained by measuring the liquid absorbability according to the Bristow method, of from 0.1 ml·m⁻²·msec^{-1/2} to 0.3 ml·m⁻²·msec^{-1/2} is used.

The coated paper is a coated paper for general printing made mainly from cellulose, such as so-called coat papers and art papers that are used in general offset printing or the like. Such a coated paper generally has a low solvent penetration speed, and when used in image formation by conventional aqueous ink-jetting, the coated paper has a tendency to cause problems in the product quality, such as bleeding of image (decrease in the resolution) or a decrease in the abrasion resistance. However, when the ink-jet recording method of the invention is used, the problem of bleeding of image or decreased abrasion resistance is suppressed, and good images may be formed.

The coated paper according to the invention has a Ka value with respect to water, which is obtained by measuring the liquid absorbability according to the Bristow method, of from 0.1 ml·m⁻²·msec^{-1/2} to 0.3 ml·m⁻²·msec^{-1/2}.

The Bristow method is the most popular method for measuring the amount of liquid absorption in a short time, and is employed also by Japan Technical Association of the Pulp and Paper Industry (J'TAPPI). Details of the testing method are described in the J. TAPPI No. 51, “Method for determining the liquid absorbability of paper and board”, the disclosure of which is incorporated by reference herein.

According to the invention, when measuring the Ka value, the head box slit width for the Bristow test is adjusted in accordance with the surface tension of the liquid to be measured. The measurement value for the point at which ink runs off to the back of the paper is excluded from the calculation.

In general, when the amount of liquid absorption of the coated paper is measured by the Bristow method, there exists an inflection point at which the absorption coefficient changes. Since the invention is under the influence of the initial absorption coefficient, the absorption coefficient up to the inflection point is used.

The coated paper used in the invention is not particularly limited as long as the Ka value is within the aforementioned range, and those generally marketed products may be used. Specific examples thereof include coat papers (A2, B2) such as “OK TOPCOAT +” manufactured by Oji Paper Co., Ltd., and “AURORACOAT” and “RECYCLECOAT T-6” manufactured by Japan Paper Group, Inc.; art paper (A1) such as “TOKUBISHI ART” manufactured by Mitsubishi Paper Mills, Ltd.; and the like.

<Aqueous Ink>

The aqueous ink according to the invention (hereinafter, may also be referred to as “ink” or “ink composition”) contains at least one colorant, at least one kind of resin particles, at least one water-soluble organic solvent, and water, and if necessary, may include other components such as surfactants.

The ink according to the invention may be used in full color image recording. To record full color images, a magenta tone ink, a cyan tone ink, and a yellow tone ink may be used, and in order to adjust the color tones, a black tone ink may be further used. In addition to the yellow, magenta and cyan tone inks, a red ink, a green ink, a blue ink, a white ink, or so-called special color inks in the printing field may also be used.

Hereinafter, the ink components will be described in detail.

(Colorant)

The colorant may be any compound having a function by which images may be formed by coloration, and any of pigments, dyes or colored particles may be used as the colorant. Among the pigments, water-dispersible pigments are preferred.

Specific examples of the water-dispersible pigment include the following pigments of (1) to (4).

(1) An encapsulated pigment, that is, a polymer dispersion in which a pigment is incorporated in polymer particles. More specifically, the encapsulated pigment is a pigment coated with a hydrophilic and water-insoluble resin and has hydrophilicity due to the resin layer provided on the surface of the pigment, and therefore, the encapsulated pigment is dispersible in water.

(2) A self-dispersing pigment, that is, a pigment which has at least one hydrophilic group at the surface, and exhibits at least any of water-solubility and water-dispersibility in the absence of dispersant. More specifically, the self-dispersing pigment is a pigment produced mainly by subjecting carbon black or the like to a surface oxidation treatment to render the pigment hydrophilic, and thus making the pigment per se to disperse in water.

(3) A resin-dispersed pigment, that is, a pigment dispersed by a water-soluble polymer compound having a weight average molecular weight of 50,000 or less.

(4) A surfactant-dispersed pigment, that is, a pigment dispersed by a surfactant.

Among these, preferable examples include the (1) encapsulated pigment and (2) self-dispersing pigment, and more preferable examples include the (1) encapsulated pigment.

Here, the (1) encapsulated pigment will be described in detail.

The resin for the encapsulated pigment is not limited, but the resin is preferably a polymer compound having self-dispersing ability or dissolving ability in a mixed solvent of water and a water-soluble organic solvent, and having an anionic group (acidic). Usually, this resin preferably has a number average molecular weight in the range of about 1,000 to 100,000, and particularly in the range of about 3,000 to 50,000. It is also preferable that this resin be dissolved in an organic solvent to form a solution. When the number average molecular weight of the resin is within this range, the resin may sufficiently exhibit its function as a coating layer for the pigment, or as a coating layer when used in an ink composition. The resin is preferably used in the form of a salt of an alkali metal or an organic amine.

Specific examples of the resin for the encapsulated pigment include materials having an anionic group, such as thermoplastic, thermosetting or modified acrylic, epoxy-based, polyurethane-based, polyether-based, polyamide-based, unsaturated polyester-based, phenolic, silicone-based or fluorine-based polymers; polyvinyl-based resins such as vinyl chloride, vinyl acetate, polyvinyl alcohol or polyvinyl butyral; polyester-based resins such as alkyd resins and phthalic acid resins; amino-based materials such as melamine resins, melamine-formaldehyde resins, aminoalkyd co-condensated resins, urea resins, and urea resins; or copolymers or mixtures thereof.

The anionic acrylic resins may be obtained by, for example, polymerizing an acryl monomer having an anionic group (hereinafter, referred to as “anionic group-containing acryl monomer”) and if necessary, another monomer capable of being copolymerized with any of these monomers, in a solvent. Examples of the anionic group-containing acryl monomer include acryl monomers having one or more anionic groups selected from the group consisting of a carboxyl group, a sulfonic acid group and a phosphonic acid group, and among them, acryl monomers having a carboxyl group are particularly preferred.

Specific examples of the acryl monomer having a carboxyl group include acrylic acid, methacrylic acid, crotonic acid, ethacrylic acid, propylacrylic acid, isopropylacrylic acid, itaconic acid, fumaric acid. Among these, acrylic acid or methacrylic acid is preferred.

The encapsulated pigment may be produced by a conventional physical or chemical method, using the above-described components. For example, in an embodiment of the present invention, the encapsulated pigment may be produced by the methods described in JP-A Nos. 9-151342, 10-140065, 11-209672, 11-172180, 10-25440 or 11-43636.

In the present invention, a self-dispersing pigment is also one of preferred examples. The self-dispersing pigment is a pigment which has a large number of hydrophilic functional groups and/or salts thereof (hereinafter, referred to as “dispersibility imparting group”) bonded to the pigment surface directly or indirectly via an alkyl group, an alkyl ether group, an aryl group or the like, and is capable of dispersing in an aqueous medium without using a dispersant. Here, the term “dispersing in an aqueous medium without using a dispersant” implies that the pigment is capable of being dispersed in an aqueous medium even though a dispersant for dispersing pigments is not used.

Since an ink containing a self-dispersing pigment as the colorant does not need to include a dispersant which is usually incorporated to disperse pigments, it is possible to easily prepare an ink in which foaming due to decrease in the defoaming property caused by the dispersant (that is, foaming associated with the use of the dispersant) scarcely occur, and which has excellent ejection stability.

Examples of the dispersibility imparting group that is bonded to the surface of the self-dispersing pigment include —COOH, —CO, —OH, —SO₃H, —PO₃H₂ and quaternary ammonium, and salts thereof The dispersibility imparting group may be bonded to the surface of the pigment that is a raw material, by applying a physical treatment or a chemical treatment to the pigment, thereby bonding (grafting) the dispersibility imparting group or an active species having a dispersibility imparting group to the pigment surface, and the self-dispersing pigment is obtained. As the physical treatment, examples thereof include vacuum plasma treatment. Examples of the chemical treatment include a wet oxidation method of oxidizing the pigment surface in water by an oxidizing agent; a method of bonding a carboxyl group via a phenyl group by bonding p-aminobenzoic acid to the pigment surface.

In the invention, the self-dispersing pigment may be, for example, a self-dispersing pigment which is surface treated by an oxidation treatment using hypohalous acid and/or hypohalite, or an oxidation treatment using ozone. As the self-dispersing pigment, a commercially available product may be used, and examples of the commercially available self-dispersing pigment include MICROJET CW-1 (trade name; manufactured by Orient Chemical Industries, Ltd.), CAB-O-JET200, CAB-O-JET300 (trade name; manufactured by Cabot Corp.).

—Pigment—

The pigment which may be used in the invention is not particularly limited, and may be appropriately selected according to the purpose, and for example, any of organic pigments and inorganic pigments may be included.

Examples of the organic pigments include azo pigments, polycyclic pigments, dye chelates, nitro pigments, nitroso pigments, aniline black. Among these, azo pigments, polycyclic pigments are more preferred. For instance, examples of the azo pigments include azo lakes, insoluble azo pigments, condensed azo pigments, chelate azo pigments. Examples of the polycyclic pigments include phthalocyanine pigments, perylene pigments, perinone pigments, anthraquinone pigments, quinacridone pigments, dioxazine pigments, indigo pigments, thioindigo pigments, isoindolinone pigments, quinophthalone pigments. Examples of the dye chelates include basic dye type chelates, acidic dye type chelates.

Examples of the inorganic pigments include titanium oxide, iron oxide, calcium carbonate, barium sulfate, aluminum hydroxide, barium yellow, cadmium red, chrome yellow, carbon black. Among these, carbon black is particularly preferred.

Here, examples of carbon black include those produced according to any of known methods such as a contact method, a furnace method and a thermal method.

As for the black pigments, specific examples of carbon black include RAVEN 7000, RAVEN 5750, RAVEN 5250, RAVEN 5000 ULTRAII, RAVEN 3500, RAVEN 2000, RAVEN 1500, RAVEN 1250, RAVEN 1200, RAVEN 1190 ULTRAII, RAVEN 1170, RAVEN 1255, RAVEN 1080, RAVEN 1060, RAVEN 700 (all manufactured by Columbian Carbon Company), REGAL 400R, REGAL 330R, REGAL 660R, MOGUL L, BLACK PEARLS L, MONARCH 700, MONARCH 800, MONARCH 880, MONARCH 900, MONARCH 1000, MONARCH 1100, MONARCH 1300, MONARCH 1400 (all manufactured by Cabot Corp.), COLOR BLACK FW1, COLOR BLACK FW2, COLOR BLACK FW2V, COLOR BLACK 18, COLOR BLACK FW200, COLOR BLACK S150, COLOR BLACK S160, COLOR BLACK S 170, PRINTEX 35, PRINTEX U, PRINTEX V, PRINTEX 140U, PRINTEX 140V, SPECIAL BLACK 6, SPECIAL BLACK 5, SPECIAL BLACK 4A, SPECIAL BLACK 4 (all manufactured by Degussa), No. 25, No. 33, No. 40, No. 45, No. 47, No. 52, No. 900, No. 2200B, No. 2300, MCF-88, MA 600, MA 7, MA 8, MA 100 (all manufactured by Mitsubishi Chemical Corp.). However, the examples are not intended to be limited to these.

As for the organic pigments which may be used in the invention, examples of the pigment for yellow ink include C.I. Pigment Yellow 1, 2, 3, 4, 5, 6, 7, 10, 11, 12, 13, 14, 14 C, 16, 17, 24, 34, 35, 37, 42, 53, 55, 65, 73, 74, 75, 81, 83, 93, 95, 97, 98, 100, 101, 104, 108, 109, 110, 114, 117, 120, 128, 129, 138, 150, 151, 153, 154, 155, 180.

Examples of the pigment for magenta ink include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 48 (Ca), 48 (Mn), 48:2, 48:3, 48:4, 49, 49:1, 50, 51, 52, 52:2, 53:1, 53, 55, 57 (Ca), 57:1, 60, 60:1, 63:1, 63:2, 64, 64:1, 81, 83, 87, 88, 89, 90, 101 (iron oxide), 104, 105, 106, 108 (Cadmium Red), 112, 114, 122 (Quinacridone Magenta), 123, 146, 149, 163, 166, 168, 170, 172, 177, 178, 179, 184, 185, 190, 193, 202, 209, 219, 269, and C.I. Pigment Violet 19. Among the pigments for magenta ink, C.I. Pigment Red 122 is preferred.

Examples of the pigment for cyan ink include C.I. Pigment Blue 1, 2, 3, 15, 15:1, 15:2, 15:3, 15:34, 16, 17:1, 22, 25, 56, 60, C.I. Vat Blue 4, 60, 63. Among the pigments for cyan ink, C.I. Pigment Blue 15:3 is preferred.

The aforementioned pigments may be used as one kind alone, or may be used in combination of two or more kinds selected from within the group or among the two or more groups.

—Dispersant—

In the invention, as the dispersant which may be used with the encapsulated pigment or resin-dispersed pigment, a nonionic compound, an anionic compound, a cationic compound, an amphoteric compound, or the like may be used.

For example, a copolymer of monomers having an α,β-ethylenic unsaturated group may be used as the dispersant. Examples of the monomer having an α,β-ethylenic unsaturated group include ethylene, propylene, butane, pentene, hexane, vinyl acetate, allyl acetate, acrylic acid, methacrylic acid, crotonic acid, crotonic acid esters, itaconic acid, itaconic acid monoesters, maleic acid, maleic acid monoesters, maleic acid diesters, fumaric acid, fumaric acid monoesters, vinylsulfonic acid, styrenesulfonic acid, sulfonated vinylnaphthalene, vinyl alcohol, acrylamide, methacryloxyethyl phosphate, bismethacryloxyethyl phosphate, methacryloxyethylphenyl acid phosphate, ethylene glycol dimethacrylate, diethylene glycol dimethacrylate, styrene, styrene derivatives such as α-methylstyrene and vinyltoluene, vinylcyclohexane, vinylnaphthalene, vinylnaphthalene derivatives, acrylic acid alkyl esters which may have an aromatic group as a substituent, acrylic acid phenyl esters, methacrylic acid alkyl esters which may have an aromatic group as a substituent, methacrylic acid phenyl esters, methacrylic acid cycloalkyl esters, crotonic acid alkyl esters, itaconic acid dialkyl esters, maleic acid dialkyl esters, vinyl alcohol, and derivatives of the aforementioned compounds.

One monomer or two or more monomers of the above described monomer having an α,β-ethylenic unsaturated group may be used for copolymerization, and the resulting copolymer may be used as a polymeric dispersant. Specific examples of the copolymer include acrylic acid alkyl ester-acrylic acid copolymers, methacrylic acid alkyl ester-methacrylic acid copolymers, styrene-acrylic acid alkyl ester-acrylic acid copolymers, styrene-methacrylic acid phenyl ester-methacrylic acid copolymers, styrene-methacrylic acid cyclohexyl ester-methacrylic acid copolymers, styrene-styrenesulfonic acid copolymers, styrene-maleic acid copolymers, styrene-methacrylic acid copolymers, styrene-acrylic acid copolymers, vinylnaphthalene-maleic acid copolymers, vinylnaphthalene-methacrylic acid copolymers, vinylnaphthalene-acrylic acid copolymers, polystyrene, polyesters, and polyvinyl alcohol.

The dispersant preferably has a weight average molecular weight of 2,000 to 60,000. The amount of addition of the dispersant with respect to the pigment is, on a mass basis, preferably in the range of 10% or more and 100% or less of the amount of the pigment, more preferably 20% or more and 70% or less of the amount of the pigment, and even more preferably 40% or more and 50% or less of the amount of the pigment.

(Water-Soluble Organic Solvent)

In the aqueous ink for ink-jet recording system, a water-soluble organic solvent. may be used as, for example, a dryness preventing agent, a wetting agent, or a penetration accelerating agent.

The dryness preventing agent is used for preventing the ink from being dried to form aggregates at the ink outlet of the ejection nozzle, and clogging the ink outlet. For the dryness preventing agent or a wetting agent, a water-soluble organic solvent having a lower vapor pressure than that of water, is preferred.

Also, as the penetration accelerating agent, which is used for enhancing the penetrability of the ink into paper, the water-soluble organic solvent is preferably used.

Examples of the water-soluble organic solvent include alkanediols or polyhydric alcohols, such as glycerin, 1,2,6-hexanetriol, trimethylolpropane, ethylene glycol, propylene glycol, diethylene glycol, triethylene glycol, tetraethylene glycol, pentaethylene glycol, dipropylene glycol, 2-butene-1,4-diol, 2-ethyl-1,3-hexanediol, 2-methyl-2,4-pentanediol, 1,2-octanediol, 1,2-hexanediol, 1,2-pentanediol, and 4-methyl-1,2-pentanediol; saccharides such as glucose, mannose, fructose, ribose, xylose, arabinose, galactose, aldonic acid, glucitol, maltose, cellobiose, lactose, sucrose, trehalose, and maltotriose; sugar alcohols; hyaluronic acids; so-called solid wetting agents such as ureas; alkyl alcohols having 1 to 4 carbon atoms, such as ethanol, methanol, butanol, propanol, and isopropanol; glycol ethers such as ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-isopropyl ether, diethylene glycol mono-isopropyl ether, ethylene glycol mono-n-butyl ether, ethylene glycol mono-t-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-isopropyl ether, dipropylene glycol monomethyl ether, dipropylene glycol monoethyl ether, dipropylne glycol mono-n-propyl ether, and dipropylene glycol mono-isopropyl ether; 2-pyrrolidone, N-methyl-2-pyrrolidone, 1,3-dimethyl-2-imidazolidinone, formamide, acetamide, dimethylsulfoxide, sorbite, sorbitan, acetin, diacetin, triacetin, sulfolane. These may be used as one kind alone, or in combination of two or more kinds.

For the purpose as a dryness preventing agent or a wetting agent, polyhydric alcohols are useful, and examples thereof include glycerin, ethylene glycol, diethylene glycol, triethylene glycol, propylene glycol, dipropylene glycol, tripropylene glycol, 1,3-butanediol, 2,3-butanediol, 1,4-butanediol, 3-methyl-1,3-butanediol, 1,5-pentanediol, tetraethylene glycol, 1,6-hexanediol, 2-methyl-2,4-pentanediol, polyethylene glycol, and 1,2,4-butanetriol, 1,2,6-hexanetriol. These may be used as one kind alone, or may be used in combination of two or more kinds.

For the purpose as a penetration accelerating agent, polyol compounds are preferred. Examples of the aliphatic diols include 2-ethyl-2-methyl-1,3-propanediol, 3,3-dimethyl-1,2-butanediol, 2,2-diethyl-1,3-propanediol, 2-methyl-2-propyl-1,3-propanediol, 2,4-dimethyl-2,4-pentanediol, 2,5-dimethyl-2,5-hexanediol, 5-hexene-1,2-diol, 2-ethyl-1,3-hexanediol. Among these, 2-ethyl-1,3-hexanediol and 2,2,4-trimethyl-1,3-pentanediol may be mentioned as preferred examples.

The water-soluble organic solvent contained in the aqueous ink of the invention preferably has a vapor pressure at 20° C. of less than 0.01 pKa, from the view point of decreasing the volatile components. Specific examples of such a water-soluble organic solvent include those described as examples of a water-soluble organic solvent contained the aqueous treatment liquid, as described in the above.

The water-soluble organic solvent used in the ink according to the invention may be used as one kind alone, or may be used as a mixture of two or more kinds.

The content of the water-soluble organic solvent(s) in the aqueous ink is preferably 1% by mass or more and 60% by mass or less, and more preferably 5% by mass or more and 40% by mass or less.

The content of water in the ink according to the invention is not particularly limited, and the content of water is not particularly limited. The content of water used in the ink is preferably 10% by mass or more and 99% by mass or less, more preferably 30% by mass or more and 80% by mass or less, and even more preferably 50% by mass or more and 70% by mass or less.

(Resin Particles)

The aqueous ink according to the invention contains at least one kind of resin particles. When resin particles are contained, mainly the fixability of the aqueous ink to the recording medium and the abrasion resistance of the image may be further enhanced. The resin particles have a function of fixing the aqueous ink, that is, the image, by causing aggregation or dispersion unstabilization when contacted with the above-described aqueous treatment liquid or a paper region where the aqueous treatment liquid has been dried, and thereby increasing the viscosity of the ink. The resin particles are preferably dispersed in water and an organic solvent.

Examples of the resin particles that may be used include acrylic resins, vinyl acetate-based resins, styrene-butadiene-based resins, vinyl chloride-based resins, acryl-styrene-based resins, butadienic resins, styrenic resins, crosslinked acrylic resins, crosslinked styrenic resins, benzoguanamine resins, phenolic reins, silicone resins, epoxy resins, urethane-based resins, paraffin-based resins, fluororesins. Various kinds of resin particles of, for example, acrylic resins, acryl-styrene-based resins, styrenic resins, crosslinked acrylic resins, crosslinked styrenic resins may be used. Particularly, acrylic resin particles are preferred.

Acrylic resins are obtained by polymerizing, for example, an acryl monomer having an anionic group (anionic group-containing acryl monomer) and as necessary, another monomer capable of being copolymerized with the anionic group-containing acryl monomer. Examples of the anionic group-containing acryl monomer include acryl monomers having one or more selected from the group consisting of a carboxyl group, a sulfonic acid group and a phosphonic acid group. Among them, acryl monomers having a carboxyl group (for example, acrylic acid, methacrylic acid, crotonic acid, ethacrylic acid, propylacrylic acid, isopropylacrylic acid, itaconic acid, fumaric acid) are preferred, and acrylic acid or methacrylic acid is particularly preferred.

As the resin particles, specifically latexes may be suitably used, and for example, various latexes such as acrylic latexes, vinyl acetate-based latexes, styrenic latexes and polyester-based latexes, may be suitably used. Particularly, acrylic latexes are preferred.

As the resin particles in the invention, self-dispersing polymer particles are preferred and self-dispersing polymer particles having a carboxyl group are more preferred, from a view point of the ejection stability and the liquid stability (particularly, dispersion stability) in a case of using a coloring material (particularly, pigment), which will be described below. The self-dispersing polymer particles mean particles of a water-insoluble polymer which can form a dispersed state in an aqueous medium by means of a functional group (particularly, an acidic group or a salt thereof) of the polymer per se in the absence of other surfactant, and are water-insoluble polymer particles which do not contain an additional separate emulsifier.

The “dispersed state” includes an emulsified state where the water-insoluble polymer is dispersed in a liquid state in an aqueous medium (emulsion) and a dispersed state where the water-insoluble polymer is dispersed in a solid state in the aqueous medium (suspension).

The water-insoluble polymer in the invention is preferably such a water-insoluble polymer that can form a dispersed state where the water-insoluble polymer is dispersed in a solid state, from a view point of the aggregation speed and the fixing property when it is formulated as a liquid composition.

The dispersed state of the self-dispersing polymer particles means such a state where stable presence of a dispersed state can be confirmed visually at 25° C. for at least one week after mixing and stirring a solution in which 30 g of a water-insoluble polymer is dissolved into 70 g of an organic solvent (for example, methyl ethyl ketone), a neutralizing agent capable of neutralizing a salt-forming group of the water-insoluble polymer to 100% (sodium hydroxide when the salt forming group is anionic or acetic acid when the group is cationic), and 200 g of water (apparatus: a stirrer equipped with a stirring blade, number of rotation: 200 rpm, 30 min, 25° C.), and then removing the organic solvent from the liquid mixture.

Further, the water-insoluble polymer means a polymer showing an amount of dissolution of 10 g or less when the polymer is dried at 105° C. for 2 hours and then dissolved in 100 g of water at 25° C. The amount of dissolution is, preferably, 5 g or less and, more preferably, 1 g or less. The amount of dissolution is the amount of dissolution when the polymer is neutralized to 100% with sodium hydroxide or acetic acid in accordance with the kind of the salt-forming group of the water-insoluble polymer.

The aqueous medium contains water and may optionally contain a hydrophilic organic solvent. In the invention, the aqueous medium preferably includes water and the hydrophilic organic solvent in an amount of 0.2 mass % or less relative to water and, more preferably, the aqueous medium consists of water.

The main chain skeleton of the water-insoluble polymer is not particularly limited and, for example, a vinyl polymer or a condensated type polymer (epoxy resin, polyester, polyurethane, polyamide, cellulose, polyether, polyurea, polyimide, polycarbonate, etc.) can be used. Among them, a vinyl polymer is particularly preferred.

Preferred examples of the vinyl polymer and the monomer used for the vinyl polymer include those described in JP-A Nos. 2001-181549 and 2002-88294. Further, vinyl polymers introduced with a dissociative group to a terminal end of a polymer chain by radical polymerization of a vinyl monomer using a chain transfer agent, a polymerization initiator, or an iniferter having a dissociative group (or a substituent that can be induced to the dissociative group) or by ionic polymerization using a compound having a dissociative group (or substituent that can be induced to the dissociative group) to an initiator or a terminator can also be used.

Preferred examples of condensated type polymers and monomers used for the condensated type polymers include those described in JP-A No. 2001-247787.

The self-dispersing polymer particles preferably contain a water-insoluble polymer containing a hydrophilic constituent unit and a constituent unit derived from an aromatic group-containing monomer from a viewpoint of the self-dispersibility.

The hydrophilic constituent unit is not particularly limited so long as it is derived from a hydrophilic group-containing monomer and it may be either a unit derived from one kind of hydrophilic group-containing monomer or a unit derived from two or more kinds of hydrophilic group-containing monomers. The hydrophilic group is not particularly limited and it may be either a dissociative group or a nonionic hydrophilic group.

In the invention, the hydrophilic group is preferably a dissociative group from a view point of promoting the self-dispersibility and a view point of stability of the formed emulsified or dispersed state and, more preferably, an anionic dissociative group. Examples of the dissociative group include a carboxylic group, a phosphoric acid group, and a sulfonic acid group and, among them, the carboxylic group is preferred from a viewpoint of the fixing property when the ink composition is formed.

The hydrophilic group-containing monomer in the invention is preferably a dissociative group-containing monomer and, preferably, a dissociative group-containing monomer having a dissociative group and an ethylenically unsaturated bond from a viewpoint of the self-dispersibility and the aggregation property.

Examples of the dissociative group-containing monomer include an unsaturated carboxylic acid monomer, an unsaturated sulfonic acid monomer, and an unsaturated phosphoric acid monomer.

Specific examples of the unsaturated carboxylic acid monomer include acrylic acid, methacrylic acid, crotonic acid, itaconic acid, maleic acid, fumaric acid, citraconic acid, and 2-methacryloyloxy methyl succinic acid, etc. Specific examples of the unsaturated sulfonic acid monomer include styrene sulfonic acid, 2-acrylamide-2-methylpropane sulfonic acid, 3-sulfopropyl(meth)acrylate, and bis(3-sulfopropyl)-itaconic acid ester. Specific examples of the unsaturated phosphoric acid monomer include vinyl phosphonic acid, vinyl phosphate, bis(methacryloyloxyethyl)phosphate, diphenyl-2-acryloyloxyethyl phosphate, diphenyl-2-methacryloyloxyethyl phosphate, and dibutyl-2-acryloyloxyethyl phosphate.

Among the dissociative group-containing monomers, the unsaturated carboxylic acid monomer is preferred and, acrylic acid and methacrylic acid are more preferred from a viewpoint of the dispersion stability and the ejection stability.

The self-dispersibility polymer particles in the invention preferably contain a polymer having a carboxyl group and contains, more preferably, a polymer having a carboxylic group and an acid value (mgKOH/g) of from 25 to 100, from a viewpoint of the self-dispersibility and the aggregation speed when the liquid composition containing the polymer particles is in contact with a treating liquid. The acid value is, more preferably, from 25 to 80 and, particularly preferably, from 30 to 65, from a viewpoint of the self-dispersibility and the aggregation speed when the liquid composition containing the polymer particles is in contact with the treating liquid.

Particularly, when the acid value is 25 or more, the stability of the self-dispersibility may be more favorable, and when the acid value is 100 or less, the aggregation property may be improved.

The aromatic group-containing monomer is not particularly limited so long as it is a compound containing an aromatic group and a polymerizable group. The aromatic group may be either a group derived from an aromatic hydrocarbon or a group derived from an aromatic heterocyclic ring. In the invention, the aromatic group is preferably an aromatic group derived from the aromatic hydrocarbon, from a viewpoint of the shape stability of particles in the aqueous medium.

The polymerizable group may be either a polycondensating polymerizable group or an addition polymerizing polymerizable group. In the invention, the polymerizable group is preferably an addition polymerizing polymerizable group, and more preferably, a group containing an ethylenically unsaturated bond from a viewpoint of shape stability of particles in the aqueous medium.

The aromatic group-containing monomer in the invention is preferably a monomer having an aromatic group derived from an aromatic hydrocarbon and an ethylenically unsaturated bond. The aromatic group-containing monomer may be used as one kind alone or two or more kinds of the aromatic group-containing monomers may be used in combination.

Examples of the aromatic group-containing monomer include phenoxyethyl(meth)acrylate, benzyl(meth)acrylate, phenyl(meth)acrylate, and styrenic monomer. Among them, from a viewpoint of the balance between the hydrophilicity and the hydrophobicity of the polymer chain and the ink fixing property, an aromatic group-containing (meth)acrylate monomer is preferred, and at least one selected from the group consisting of phenoxyethyl(meth)acrylate, benzyl(meth)acrylate, and phenyl(meth)acrylate is more preferable and, phenoxyethyl(meth)acrylate and benzyl(meth)acrylate are still more preferred.

“(Meth)acrylate” means acrylate or methacrylate, “(meth)acrylamide” means acrylamide or methacrylamide, and “(meth)acrylic” means acrylic or methacrylic.

The self-dispersing polymer particles in the invention preferably contain a constituent unit derived from the aromatic group-containing (meth)acrylate monomer and the content thereof is, preferably, from 10 mass % to 95 mass %. When the content of the constituent unit derived from the aromatic group-containing (meth)acrylate monomer is from 10 mass % to 95 mass %, the stability of the self-emulsified or dispersed state is improved and, further, increase in the viscosity of an ink can be suppressed.

In the invention, the content of a constituent unit derived from the aromatic group-containing (meth)acrylate monomer in the self-dispersing polymer particles is, more preferably, from 15 mass % to 90 mass %, further preferably, from 15 mass % to 80 mass % and, particularly preferably, from 25 mass % to 70 mass % from a viewpoint of the stability of the self-dispersed state, stabilization for the shape of the particles in the aqueous medium due to hydrophobic inter-action between aromatic rings to each other, and lowering of the amount of the water-soluble component due to appropriate hydrophobic property of the particles.

The self-dispersing polymer particles in the invention can be formed by using, for example, a constituent unit derived from an aromatic group-containing monomer and a constituent unit derived from a dissociative group-containing monomer. The polymer particles may further contain additional constituent unit(s) optionally.

The monomer which may be used for forming the additional constituent unit is not particularly limited so long as it is a monomer copolymerizable with the aromatic group-containing monomer and the dissociative group-containing monomer. Among all, an alkyl group-containing monomer is preferred from a viewpoint of the flexibility of the polymer skeleton or easiness in control for the glass transition temperature (Tg).

Examples of the alkyl group-containing monomer include alkyl(meth)acrylates such as methyl(meth)acrylate, ethyl(meth)acrylate, isopropyl(meth)acrylate, n-propyl(meth)acrylate, n-butyl(meth)acrylate, isobutyl(meth)acrylate, t-butyl(meth)acrylate, hexyl(meth)acrylate, and ethylhexyl(meth)acrylate; ethylenically unsaturated monomers having a hydroxyl group such as hydroxymethyl(meth)acrylate, 2-hydroxyethyl(meth)acrylate, 2-hydroxypropyl(meth)acrylate, 4-hydroxybutyl(meth)acrylate, hydorxypentyl(meth)acrylate, and hydroxyhexyl(meth)acrylate; dialkylamino alkyl(meth)acrylates such as dimethylaminoethyl(meth)acrylate; (meth)acrylamides, for example, N-hydroxyalkyl(meth)acrylamide such as N-hydroxymethyl(meth)acrylamide, N-hydroxyethyl(meth)acrylamide, and N-hydroxybutyl(meth)acrylamide; and N-alkoxyalkyl(meth)acrylamides such as N-methoxymethyl(meth)acrylamide, N-ethoxymethyl(meth)acrylamide, N-(n-, iso)butoxymethyl(meth)acrylamide, N-methoxyethyl(meth)acrylamide, N-ethoxyethyl(meth)acrylamide, and N-(n-, iso)butoxyethyl(meth)acrylamide.

The range for the molecular weight of the water-insoluble polymer that is used in the self-dispersing polymer particles in the invention is, preferably, from 3,000 to 200,000 and, more preferably, from 5,000 to 150,000 and, further preferably, from 10,000 to 100,000 as the weight average molecular weight. The amount of the water-soluble component can be suppressed effectively when the weight average molecular weight is 3,000 or more. Further, the self-dispersion stability can be increased when the weight average molecular weight is 200,000 or less.

The weight average molecular weight is measured by gel permeation chromatography (GPC). In GPC, HLC-802OGPC (manufactured by Tosoh Corporation) is used, and 3 pieces of colums of TSKgel Super HZM-H, TSK gel Super HZ4000 and TSK gel Super HZ200 (trade names, manufactured by Tosoh Corporation, 4.6 mm ID×15 cm) were used, and THF (tetrahydrofuran) is used as an eluate. Measurement is performed by using an IR detector under the conditions at a sample concentration of 0.35 mass %, a flow rate of 0.35 mL/min, a sample ejection amount of 10 μL, and a measuring temperature of 40° C. A calibration curve is prepared based on eight samples of “standard sample: TSK standard polystyrene” of “F-40”, “F-20”, “F-4”, “F-1”, “A-5000”, “F-2500”, “A-1000”, and “n-propylbenzene” manufactured by Tosoh Corporation.

The water-insoluble polymer used for the self-dispersing polymer particle in the invention preferably contains a structural unit derived from an aromatic group-containing (meth)acrylate monomer (preferably, structural unit derived from phenoxyethyl(meth)acrylate and/or structural unit derived from benzyl(meth)acrylate) in an amount of from 15 to 80 mass % as the copolymerization ratio based on the entire mass of the self-dispersing polymer particles from a viewpoint of controlling the hydrophilicity and hydrophobicity of the polymer.

Further, the water-insoluble polymer preferably contains a constituent unit derived from an aromatic group-containing (meth)acrylate monomer in an amount of from 15 to 80 mass % as the copolymerization ratio, a constituent unit derived from a carboxyl group-containing monomer, and a constituent unit derived from an alkyl group-containing monomer (preferably, constituent unit derived from (meth)acrylic acid alkyl ester). The water-insoluble polymer more preferably contains a structural unit derived from phenoxyethyl(meth)acrylate and/or structural unit derived from benzyl(meth)acrylate in an amount of from 15 to 80 mass % as the copolymerization ratio, a constituent unit derived from a carboxyl group-containing monomer, and a constituent unit derived from an alkyl group-containing monomer (preferably, a structural unit derived from an ester of alkyl having 1 to 4 carbon atoms of (meth)acrylic acid). Further, the water-insoluble polymer has preferably an acid value of from 25 to 100 and a weight average molecular weight of from 3,000 to 200,000 and, more preferably, an acid value of from 25 to 95 and a weight average molecular weight of from 5,000 to 150,000, from a viewpoint of controlling the hydrophilicity and hydrophobicity of the polymer.

As specific examples of the water-insoluble polymer that is used in the self-dispersing polymer particles, exemplary compounds B-01 to B-19 are shown below but in the invention the water-insoluble polymer is not limited to them. Numericals described in each parenthesis represents the mass ratio of the copolymer components.

B-01: phenoxyethyl acrylate/methyl methacrylate/acrylic acid copolymer (50/45/5)
B-02: phenoxyethyl acrylate/benzyl methacrylate/isobutyl methacrylate/methacrylic acid copolymer (30/35/29/6)
B-03: phenoxyethyl methacrylate/isobutyl methacrylate/methacrylic acid copolymer (50/44/6)
B-04: phenoxyethyl acrylate/methyl methacrylate/ethyl acrylate/acrylic acid copolymer (30/55/10/5)
B-05: benzyl methacrylate/isobutyl methacrylate/methacrylic acid copolymer (35/59/6)
B-06: styrene/phenoxyethyl acrylate/methyl methacrylate/acrylic acid copolymer (10/50/35/5)
B-07: benzyl acrylate/methyl methacrylate/acrylic acid copolymer (55/40/5)
B-08: phenoxyethyl methacrylate/benzyl acrylate/methacylic acid copolymer (45/47/8)
B-09: styrene/phenoxyethyl acrylate/butyl methacrylate/acrylic acid copolymer (5/48/40/7)
B-10: benzyl methacrylate/isobutyl methacrylate/cyclohexyl methacrylate/methacrylic acid copolymer (35/30/30/5)
B-11: phenoxyethyl acrylate/methyl methacrylate/butyl acrylate/methacrylic acid copolymer (12/50/30/8)
B-12: benzyl acrylate/isobutyl methacrylate/acrylic acid copolymer (93/2/5)
B-13: styrene/phenoxyethyl methacrylate/butyl acrylate/acrylic acid copolymer (50/5/20/25)
B-14: styrene/butyl acrylate/acrylic acid copolymer (62/35/3)
B-15: methyl methacrylate/phenoxyethyl acrylate/acrylic acid copolymer (45/51/4)
B-16: methyl methacrylate/phenoxyethyl acrylate/acrylic acid copolymer (45/49/6)
B-17: methyl methacrylate/phenoxyethyl acrylate/acrylic acid copolymer (45/48/7)
B-18: methyl methacrylate/phenoxyethyl acrylate/acrylic acid copolymer (45/47/8)
B-19: methyl methacrylate/phenoxyethyl acrylate/acrylic acid copolymer (45/45/10)

The method of producing a water-insoluble polymer that is used in the self-dispersing polymer particle in the invention is not particularly limited. Examples of the method of producing the water-insoluble polymer include a method of performing emulsion polymerization under the presence of a polymerizable surfactant thereby covalently-bonding the surfactant and the water-insoluble polymer and a method of copolymerizing a monomer mixture containing the hydrophilic group-containing monomer and the aromatic group-containing monomer by a known polymerization method such as a solution polymerization method or a bulk polymerization method. Among the polymerization methods described above, the solution polymerization method is preferred and a solution polymerization method of using an organic solvent is more preferred from a viewpoint of aggregation speed and the stability of droplet ejection of the ink composition.

From a viewpoint of the aggregation speed, it is preferred that the self-dispersing polymer particles in the invention contain a polymer synthesized in an organic solvent, and the polymer has a carboxyl group (the acid value is preferably from 20 to 100), in which the carboxyl groups of the polymer are partially or entirely neutralized and the polymer is prepared as a polymer dispersion in a continuous phase of water. That is, the self-dispersing polymer particle in the invention is prepared by a method including a step of synthesizing the polymer in the organic solvent and a dispersion step of forming an aqueous dispersion in which at least a portion of the carboxyl groups of the polymer is neutralized.

The dispersion step preferably includes the following step (1) and step (2).

Step (1): step of stirring a mixture containing a polymer (water-insoluble polymer), an organic solvent, a neutralizing agent, and an aqueous medium,

Step (2): step of removing the organic solvent from the mixture.

The step (1) preferably a treatment that includes at first dissolving the polymer (water-insoluble polymer) in the organic solvent and then gradually adding the neutralizing agent and the aqueous medium, and mixing and stirring the mixture to obtain a dispersion. By adding the neutralizing agent and the aqueous medium to the solution of the water-insoluble polymer dissolved in the organic solvent, self-dispersing polymer particles having a particle size that enables higher storage stability can be obtained without requiring strong sharing force.

The stirring method for stirring the mixture is not particularly limited and a mixing and stirring apparatus that is used generally can be used, and optionally, a disperser such as a ultrasonic disperser or a high pressure homogenizer can be used.

Preferable examples of the organic solvent include alcohol type solvents, ketone type solvents and ether type solvents.

Examples of the alcohol type solvent include isopropyl alcohol, n-butanol, t-butanol, and ethanol. Examples of the ketone type solvent include acetone, methyl ethyl ketone, diethyl ketone, and methyl isobutyl ketone. Examples of the ether type solvent include dibutyl ether and dioxane. Among the solvents, the ketone type solvent such as methyl ethyl ketone and the alcohol type solvent such as propyl alcohol are preferred. Further, with an aim of moderating the change of polarity at the phase transfer from an oil system to an aqueous system, combined use of isopropyl alcohol and methyl ethyl ketone is also preferred. By the combined use of the solvents, self-dispersing polymer particles of small particle size with no aggregation settling or fusion between particles to each other and having high dispersion stability may be obtained.

The neutralizing agent is used to partially or entirely neutralize the dissociative groups so that the self-dispersing polymer can form a stable emulsified or dispersed state in water. In a case where the self-dispersing polymer of the invention has an anionic dissociative group (for example, carboxyl group) as the dissociative group, examples of the neutralizing agent to be used include basic compounds such as organic amine compounds, ammonia, and alkali metal hydroxides. Examples of the organic amine compounds include monomethyl amine, dimethyl amine, trimethyl amine, monoethyl amine, diethyl amine, triethyl amine, monopropyl amine, dipropyl amine, monoethanol amine, diethanol amine, triethanol amine, N,N-dimethyl-ethanol amine, N,N-diethyl-ethanol amine, 2-diethylamino-2-methyl-1-propanol, 2-amino-2-methyl-1-propanol, N-methyldiethanol amine, N-ethyldiethanol amine, monoisopropanol amine, diisopropanol amine, and triisopropanol amine, etc. Examples of the alkali metal hydroxide include lithium hydroxide, sodium hydroxide and potassium hydroxide. Among them, sodium hydroxide, potassium hydroxide, triethylamine, and triethanol amine are preferred from a viewpoint of the stabilization of dispersion of the self-dispersing polymer particles of the invention into water.

The basic compound is used preferably in an amount of from 5 to 120 mol %, more preferably, from 10 to 110 mol %, and further preferably, from 15 to 100 mol %, relative to 100 mol % of the dissociative groups. When the basic compound is used in an amount of 15 mol % or more, the effect of stabilizing the dispersion of the particles in water may be obtained and when the basic compound is in an amount of 100% or less, the effect of decreasing the water-soluble component may be provided.

In the step (2), an aqueous dispersion of the self-dispersing polymer particles can be obtained by phase transfer to the aqueous system by distilling off the organic solvent from the dispersion obtained in the step (1) by a common method such as distillation under a reduced pressure. In the obtained aqueous dispersion, the organic solvent has been substantially removed and the amount of the organic solvent is preferably from 0.2 mass % or less and, more preferably, 0.1 mass % or less.

The weight average molecular weight of the resin particles is preferably 10,000 or more and 200,000 or less, and more preferably 100,000 or more and 200,000 or less. The average particle size of the resin particles is, as a volume average particle size, preferably in the range of 10 nm to 1 μm, more preferably in the range of from 10 nm to 200 nm, even more preferably in the range of from 20 nm to 100 nm, and particularly preferably in the range of from 20 nm to 50 nm.

The content of the resin particles in the ink is preferably 0.5 to 20% by mass, more preferably 3 to 20% by mass, and even more preferably 5 to 15% by mass, relative to the ink.

The glass transition temperature (Tg) of the resin particles is preferably 30° C. or higher, more preferably 40° C. or higher, and even more preferably 50° C. or higher.

The particle size distribution of the polymer particles is not particularly limited, and any of those particles having a broad particle size distribution or those particles having a monodisperse particle size distribution may be used. A mixture of two or more species of polymer particles having a monodisperse particle size distribution may also be used.

(Surfactant)

The ink according to the invention may contain a surfactant, if necessary. The surfactant may be used as a surface tension adjusting agent.

Examples of the surface tension adjusting agent include a nonionic surfactant, a cationic surfactant, an anionic surfactant a betaine surfactant. The surface tension adjusting agent may be contained in an amount such that the surface tension of the ink may be adjusted to 20 to 60 mN/m, for performing the ejection of the ink satisfactorily by an ink-jet method, and more preferably to a surface tension of 20 to 45 mN/m, and even more preferably 25 to 40 mN/m.

As a surfactant which may be used in the invention, a compound having a structure in which a hydrophilic moiety and a hydrophobic moiety are contained in the molecule may be effectively used, and any of anionic surfactants, cationic surfactants, amphoteric surfactants, and nonionic surfactants may be used. Further, the polymers (polymeric dispersant) as described above may be used as surfactants.

Specific examples of the anionic surfactants include sodium dodecyl benzenesulfonate, sodium lauryl sulfate, sodium alkyl diphenyl ether disulfonates, sodium alkylnaphthalenesulfonates, sodium dialkylsulfosuccinates, sodium stearate, potassium oleate, sodium dioctylsulfosuccinate, sodium polyoxyethylene alkyl ether sulfonates, sodium polyoxyethylene alkyl ether sulfates, sodium polyoxyethylene alkyl phenyl ether sulfates, sodium dialkylsulfosuccinates, sodium stearate, sodium oleate, t-octylphenoxyethoxypolyethoxyethyl sulfuric acid sodium salt. Only one of these compounds may be selected or two or more of these compounds may be selected.

Specific examples of the nonionic surfactants include polyoxyethylene lauryl ether, polyoxyethylene octyl phenyl ether, polyoxyethylene oleyl phenyl ether, polyoxyethylene nonyl phenyl ether, oxyethylene oxypropylene block copolymers, t-octylphenoxyethylpolyethoxyethanol, nonylphenoxyethylpolyethoxyethanol. Only one of these compounds may be selected or two or more of these compounds may be selected.

Specific examples of the cationic surfactants include tetraalkylammonium salts, alkylamine salts, benzalkonium salts, alkylpyridium salts, imidazolium salts. Specifically, examples thereof include dihydroxyethylstearylamine, 2-heptadecenylhydroxyethylimidazoline, lauryldimethylbenzylammonium chloride, cetylpyridinium chloride, stearamidomethylpyridium chloride.

The content of the surfactant in the ink composition in the invention is not particularly limited. The content of the surfactant(s) is preferably 1% by mass or more, more preferably 1 to 10% by mass, and even more preferably 1 to 3% by mass.

(Other Components)

The ink composition in the invention may further contain various additives as other components according to necessity.

Examples of the various additives include those known additives such as an ultraviolet absorbent, a fading preventing agent, an anti-mold agent, a pH adjusting agent, an anti-rust agent, an antioxidant, an emulsion stabilizer, a preservative, an antifoaming agent, a viscosity adjusting agent, a dispersion stabilizer, and a chelating agent.

Examples of the ultraviolet absorbent include benzophenone-based ultraviolet absorbents, benzotriazole-based ultraviolet absorbents, salicylate-based ultraviolet absorbents, cyanoacrylate-based ultraviolet absorbents, and nickel complex salt-based ultraviolet absorbents.

As the fading preventing agent, any of various organic fading preventing agents and metal complex-based fading preventing agents may be used. Examples of the organic fading preventing agent include hydroquinones, alkoxyphenols, dialkoxyphenols, phenols, anilines, amines, indanes, chromans, alkoxyanilines, and heterocycles. Examples of the metal complex include nickel complexes, and zinc complexes.

Examples of the anti-mold agent include sodium dehydroacetate, sodium benzoate, sodium pyridinethione-1-oxide, p-hydroxybenzoic acid ethyl ester, 1,2-benzisothiazolin-3-one, sodium sorbate, pentachlorophenol sodium. These may be preferably used in the ink in an amount of 0.02 to 1.00% by mass.

The pH adjusting agent is not particularly limited as long as the agent may adjust the pH to a desired value without exerting any adverse effects on the aqueous ink to be prepared, and may be appropriately selected according to the purpose. Examples thereof include alcohol amines (for example, diethanolamine, triethanolamine, 2-amino-2-ethyl-1,3-propanediol), alkali metal hydroxides (for example, lithium hydroxide, sodium hydroxide, potassium hydroxide), ammonium hydroxides (for example, ammonium hydroxide, quaternary ammonium hydroxide), phosphonium hydroxide, alkali metal carbonates.

Examples of the anti-rust agent include acidic sulfurous acid salts, sodium thiosulfate, ammonium thiodiglycolate, diisopropylammonium nitrite, pentaerythritol tetranitrate, dicyclohexylammonium nitrite.

Examples of the antioxidant include phenol-based antioxidants (including hindered phenol-based antioxidants), amine-based antioxidants, sulfur-based antioxidants, phosphorus-based antioxidants.

Examples of the chelating agent include sodium ethylenediaminetetraacetate, sodium nitrilotriacetate, sodium hydroxyethylethylenediaminetriacetate, sodium diethylenetriaminepentaacetate, sodium uramyldiacetate.

<Properties of Ink>

The surface tension of the ink according to the invention is preferably 20 mN/m or more and 60 mN/m or less. More preferably, the surface tension is 20 mN/m or more and 45 mN/m or less, and even more preferably 25 mN/m or more and 40 mN/m or less.

The viscosity at 20° C. of the ink according to the invention is preferably 1.2 mPa·s or more and 15.0 mPa·s or less, more preferably 2 mPa·s or more and less than 13 mPa·s, and even more preferably 2.5 mPa·s or more and less than 10 mPa·s.

The viscosity can be measured using a viscometer (model name: TV-22, manufactured by Toki Sangyo Co., Ltd.).

[Ink-jet Recording Method]

The ink-jet recording method of the invention includes recording an image by ejecting an aqueous ink containing a colorant, resin particles, a water-soluble organic solvent and water by an ink-jet method, on a coated paper having a Ka value with respect to water, which is obtained by measuring the liquid absorbability according to the Bristow method, of from 0.1 ml·m⁻²·msec^{-1/2} to 0.3 ml·m⁻²·msec^{-1/2} (an image recording step); and supplying, onto the coated paper, an aqueous treatment liquid containing a fixing agent for fixing the components in the aqueous ink, and a water-soluble organic solvent which is contained in an amount of 70% by mass or more relative to the total amount of water-soluble organic solvents contained in the aqueous treatment liquid and has an SP value of 27.5 or less and a boiling point at 101.3 kPa of from 230° C. to 280° C. (a treatment liquid supplying step).

Since the ink-jet recording method has the above described structure, the abrasion resistance of images may be favorable, the fluctuation in the diameter of the dot of second color may be small, the resolution may be high, and, the occurrence of curling in the recording medium may be suppressed.

The image recording method of the invention may also include additional step(s), if necessary.

According to the invention, the image recording step is preferably a step in which the aqueous ink is ejected onto the coated paper onto which the aqueous treatment liquid has been supplied in the treatment liquid supplying step, from the viewpoint of the quality of the images formed.

<Treatment Liquid Supplying Step>

According to the invention, in the supplying of a treatment liquid onto a specific coated paper (recording medium), a known liquid supplying method may be used without particular limitation, and the aqueous treatment liquid may be supplied by the ink-jet method that will be described later, or by spray coating, with a coating roller, or the like.

Examples of the method for supplying the aqueous treatment liquid include size press methods represented by a horizontal size press method, a roll coater method, a calendar size press method, and the like; knife coater methods represented by an air knife coater method; roll coater methods represented by a transfer roll coater method such as a gate roll coater method, a direct roll coater method, a reverse roll coater method, a squeeze roll coater method, and the like; blade coater methods represented by a bill blade coater method, a short dwell coater method, a two stream coater method and the like; bar coater methods represented by a rod bar coater method; bar coater methods represented by a rod bar coater method; cast coater methods; gravure coater method; curtain coater methods; die coater methods; brush coater methods; transfer methods; and the like.

Furthermore, when a coating apparatus equipped with a liquid amount restricting member, such as the coating apparatus described in JP-A No. 10-230201, is used, the amount of coating can be controlled.

According to the invention, in regard to the region on a recording medium where the treatment liquid is supplied, the treatment liquid may be supplied over the entire surface of the recording medium (entire surface supply), or may be supplied onto a region where ink-jet recording is performed (partial supply). According to the invention, it is preferable to employ an entire surface supply in which the treatment liquid is supplied over the entire surface of the recording medium, using a coating roller or the like, in view of uniformly adjusting the amount of supply of the treatment liquid, and suppressing image irregularities.

The amount the treatment liquid supplied in the treatment liquid supplying step is not particularly limited as long as it is an amount capable of fixing the components in an aqueous ink that is ejected on a coated paper during the image recording step. According to the invention, the amount of the fixing agent supplied is preferably 0.25 g/m² or more, more preferably 0.25 g/m² or more and less than 2 g/m², and even more preferably 0.4 g/m² or more and less than 1 g/m², from the viewpoint of suppressing curling and abrasion resistance.

<Treatment Liquid Drying Step>

In the ink-jet recording method of the invention, it is preferable to provide, after supplying a treatment liquid in the treatment liquid supplying step, a treatment liquid drying step for removing by drying at least a portion of the water or water-soluble organic solvent that is included in the treatment liquid. Thereby, the occurrence of curling, cockling and ink splatter may be more effectively suppressed, and abrasion resistance of the images formed may be further enhanced.

The treatment liquid drying step is not particularly limited as long as the step involves removing by drying at least a portion of the solvent (for example, water or water-soluble organic solvent) contained in the treatment liquid that is supplied onto the recording medium, and the step may be carried out according to a conventionally used method such as air blowing or heating.

<Image Recording Step>

The ink-jet recording method of the invention includes an image recording step for recording an image by ejecting at least one aqueous ink which contains a colorant, resin particles, a water-soluble organic solvent and water, onto a specific coated paper by an ink-jet method. Thereby, satisfactory images may be recorded.

According to the invention, the occurrence of curling, cockling and ink splatter may be more effectively suppressed by supplying an aqueous ink onto a region on the coated paper where the aqueous treatment liquid has been previously supplied, and thus images having more favorable abrasion resistance may be recorded.

That is, the image recording step according to the invention is preferably a step of ejecting an aqueous ink onto a coated paper onto which an aqueous treatment liquid has been supplied in the treatment liquid supplying step.

(Ink-Jet Method)

The ink-jet method according to the invention is not particularly limited, and any known method, for example, a charge control method of ejecting an ink by making use of electrostatic attraction force, a drop on demand method of utilizing the vibration pressure of a piezo element (pressure pulse method), an acoustic ink-jet method of converting electric signals into acoustic beams, irradiating the beams to an ink, and ejecting the ink by using radiation pressure, and a thermal ink-jet method of heating an ink to form bubbles and utilizing the resultant pressure, may be used.

As an ink-jet method preferable for the invention, for example, the descriptions in paragraphs [0093] to [0105] of JP-A No. 2003-306623 may be applied.

The image recording step according to the invention may further include other steps, as necessary. Examples of the other steps include an ink drying step, a heating step, and the like.

According to the invention, it is preferable that the method further includes during an ink (an ink drying step), after ejecting the aqueous ink on a coated paper (an ink ejection step), from the viewpoint of suppressing the occurrence of curling and cockling and enhancing the abrasion resistance of images.

The ink drying step (hereinafter, may also be referred to as “drying and removal step”) is not particularly limited as long as the step involves removing by drying at least a portion of the solvent (water or water-soluble organic solvent) contained in the aqueous ink that will be supplied onto the recording medium, and the step may be carried out according to a usually used method such as air blowing or heating.

According to the invention, it is preferable that the method further includes heating (a heating step), after the ink ejection step for ejecting an aqueous ink onto a coated paper, from the viewpoint of the abrasion resistance of images. Furthermore, according to the invention, it is more preferable that the method includes an ink drying step between the ink ejection step and the heating step.

The heating step (hereinafter, may be referred to as “heating and fixing step”) is not particularly limited as long as the step is capable of melting and fixing the resin particles contained in the aqueous ink that is used in the ink-jet recording method of the invention, and may be appropriately selected in accordance with the purpose. For example, heating and fixing by utilizing a silicone rubber roller, and heating by means of a plate heater may be mentioned.

According to the invention, it is preferable that the heating step is carried out by heating and fixing by utilizing a silicone rubber roller, from the viewpoint of abrasion resistance.

The conditions for heating and fixing such as the hardness of the silicone rubber roller, heating temperature and pressure that are used in the heating and fixing by utilizing a silicone rubber roller in the invention may be appropriately selected according to the purpose.

Furthermore, according to the invention, a polymer latex compound may also be used in combination, for the purpose of imparting glossiness or water resistance or improving weather resistance upon recording images. The timing for supplying a latex compound onto the coated paper (recording medium) may be before, after, or simultaneously with the supply of the aqueous ink. Therefore, the place of addition may be in the recording medium or may also be in the aqueous ink, or the polymer latex compound may be used as a liquid substance of polymer latex alone.

Specifically, the methods described in JP-A No. 2002-166638, JP-A No. 2002-121440, JP-A No. 2002-154201, JP-A No. 2002-144696, JP-A No. 2002-080759, and the like may be preferably used.

### EXAMPLES

Hereinafter, the present i invention will be described in detail by way of examples but the invention is not limited to the following examples so long as they are within the gist of the invention. Here, unless stated otherwise, the “part” and “%” are on a mass basis.

<Preparation of Aqueous Ink>

(1) Preparation of Cyan Pigment Ink C

—Preparation of Pigment Dispersion Liquid—

10 g of CYANINE BLUE A-22 (PB 15:3, manufactured by Dainichiseika Color & Chemicals Manufacturing Co., Ltd.) as a colorant, 10.0 g of the low molecular weight dispersant shown below, 3.0 g of glycerin, and 27 g of ion-exchanged water were mixed while the mixture was stirred, and thus a crude dispersion was obtained. Subsequently, the resulting crude dispersion was subjected to intermittent ultrasonication (ultrasonication was applied for 0.5 seconds and paused for 1.0 second) for two hours, using an ultrasonicator (trade name: VIBRA-CELL VC-750, manufactured by Sonics & Materials, Inc.; tapered microtip: φ5 mm, amplitude: 30%), to further disperse the pigment, and a 20% pigment dispersion liquid was obtained.

Low Molecular Weight Dispersant

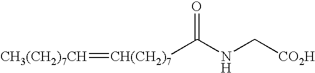

—Preparation of Mixed Liquid I—

Apart from the preparation described above, the compounds of the composition shown below were weighed and then mixed while stirred, to prepare a mixed liquid I.

Composition

| | |
|---|---|
| Glycerin (water-soluble organic solvent) | 2.0 g |
| Diethylene glycol monobutyl ether (water-soluble organic | 13.0 g |
| solvent) | |
| OLFINE E 1010 (nonionic surfactant, manufactured by Nisshin | 1.5. g |
| Chemical Industry Co., Ltd.) | |
| Ion-exchanged water | 9.5 g |

—Preparation of Self-Dispersing Polymer Particles—

In a 2-liter three-necked flask equipped with a stirrer, a thermometer, a reflux cooling tube and a nitrogen gas inlet tube, 360.0 g of methyl ethyl ketone was introduced and the temperature was raised to 75° C. While the temperature of the inside of the reaction vessel was maintained at 75° C., a mixed solution of 180.0 g of phenoxyethyl acrylate, 162.0 g of methyl methacrylate, 18.0 g of acrylic acid, 72 g of methyl ethyl ketone, and 1.44 g of “V-601” (manufactured by Wako Pure Chemical Industries, Ltd.), was added dropwise to the flask at a constant rate, such that the dropwise addition was completed in two hours. After completion of the dropwise addition, a solution of 0.72 g of “V-601” and 36.0 g of methyl ethyl ketone was added, and the mixture was stirred for two hours at a temperature of 75° C. Then, a solution of 0.72 g of “V-601” and 36.0 g of isopropanol was further added, and the mixture was stirred for two hours at a temperature of 75° C., after which the temperature was raised to 85° C., and the mixture was continuously stirred for additional two hours.

Accordingly a polymer solution was obtained. The weight average molecular weight (Mw) of the resulting copolymer was 64,000 (measured by gel permeation chromatography (GPC) and calculated based on polystyrene standards; the column used was TSK-GEL SUPER HZM-H, TSK-GEL SUPER HZ4000, TSK-GEL SUPER HZ200 (manufactured by Tosoh Corp.)), and the acid value was 38.9 (mg KOH/g).

Subsequently, 668.3 g of the thus obtained polymer solution was weighed, and to this 668.3 g of the polymer solution in the reaction vessel, 388.3 g of isopropanol, and 145.7 ml of a 1 mol/L aqueous solution of NaOH were added. The temperature of the inside of the reaction vessel was raised to 80° C. Subsequently, 720.1 g of distilled water was added dropwise at a rate of 20 ml/min, to disperse the reaction mixture in water. Thereafter, under the atmospheric pressure, the temperature of the inside of the reaction vessel was maintained at 80° C. for 2 hours, at 85° C. for 2 hours, and at 90° C. for 2 hours. Subsequently, the pressure of the inside of the reaction vessel was reduced, and 913.7 g in total of isopropanol, methyl ethyl ketone and distilled water was distilled off, to obtain an aqueous dispersion (emulsion) of self-dispersing polymer particles (B-01) at a solids concentration of 28.0%.

Here, the structure of the self-dispersing polymer particles (B-01) was as shown below. The numeral at the lower right corner of the respective constituent units in the following structure represents the “mass ratio.”

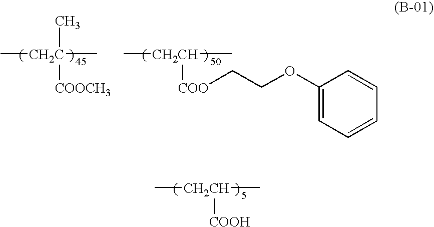

—Preparation of Aqueous Ink—

The mixed liquid I obtained as described above was slowly added dropwise to 36.2 g of the aqueous dispersion of self-dispersing polymer particles (B-01) at a solid concentration of 28.0%, which was kept stirred, and the mixture was stirred to mix, to prepare a mixed liquid II. While the resulting mixed liquid II was slowly added dropwise to the 20% pigment dispersion liquid obtained as described above, the mixture was stirred to mix. Thus, 100 g of an ink composition, cyan pigment ink C (cyan ink), was prepared.

The pH of the cyan pigment ink C was measured using a pH meter (trade name: WM-50EG, manufactured by DKK-Toa Corp.), and the pH value was 8.7.

(2) Preparation of Magenta Pigment Ink M

A magenta pigment ink M (magenta ink) was prepared by the same method as that used in the preparation of the cyan pigment ink C, except that the CYANINE BLUE A-22 used as a pigment in the preparation of the cyan pigment ink C was replaced with CROMOPHTAL JET MAGENTA DMQ (PR-1 22, manufactured by Ciba Specialty Chemicals, Inc.).

The pH of the magenta pigment ink M was measured using a pH meter (trade name WM-50EG, manufactured by DKK-Toa Corp.), and the pH value was 8.7.

(3) Preparation of Yellow Pigment Ink Y

A yellow pigment ink Y (yellow ink) was prepared by the same method as that used in the preparation of the cyan pigment ink C, except that the CYANINE BLUE A-22 used as a pigment in the preparation of the cyan pigment ink C was replaced with IRGALITE YELLOW GS (PY 74, manufactured by Ciba Specialty Chemicals, Inc.).

The pH of the yellow pigment ink Y was measured using a pH meter (trade name WM-50EG, manufactured by DKK-Toa Corp.), and the pH value was 8.7.

(4) Preparation of Black Pigment Ink K

A black pigment ink K (black ink) was prepared by the same method as that used in the preparation of the cyan pigment ink C, except that a pigment dispersion, CAB-O-JETTM 200 (carbon black, manufactured by Cabot Corp.), was used in place of the pigment dispersion liquid prepared in the preparation of the cyan pigment ink C.

The pH of the black pigment ink K was measured using a pH meter (trade name WM-50EG, manufactured by DKK-Toa Corp.), and the pH value was 8.7.

<Preparation of Aqueous Treatment Liquid>

(Treatment Liquid 1)

A treatment liquid 1 was prepared by mixing the following materials.

| | |
|---|---|
| Malonic acid (aggregating agent) | 25 g |
| Diethylene glycol monobutyl ether | 20 g |
| Ion-exchanged water | 54 g |
| OLFINE E1010 (manufactured by Nisshin Chemical Industry Co., | 1 g |
| Ltd.) | |

(Treatment Liquid 2)

A treatment liquid 2 was prepared by mixing the following materials.

| | |
|---|---|
| Malonic acid (aggregating agent) | 25 g |
| Triethylene glycol monomethyl ether | 20 g |
| Ion-exchanged water | 54 g |
| OLFINE E1010 (manufactured by Nisshin Chemical Industry Co., | 1 g |
| Ltd.) | |

(Treatment Liquid 3)

A treatment liquid 3 was prepared by mixing the following materials.

| | |
|---|---|
| Malonic acid (aggregating agent) | 25 g |
| Triethylene glycol monobutyl ether | 20 g |
| Ion-exchanged water | 54 g |
| OLFINE E1010 (manufactured by Nisshin Chemical Industry Co., | 1 g |
| Ltd.) | |

(Treatment Liquid 4)

A treatment liquid 4 was prepared by mixing the following materials.

| | |
|---|---|
| Malonic acid (aggregating agent) | 25 g |
| Dipropylene glycol | 20 g |
| Ion-exchanged water | 54 g |
| OLFINE E1010 (manufactured by Nisshin Chemical Industry Co., | 1 g |
| Ltd.) | |

(Treatment Liquid 5)

A treatment liquid 5 was prepared by mixing the following materials.

| | |
|---|---|
| Calcium nitrate | 25 g |
| Diethylene glycol monobutyl ether | 15 g |
| OLFINE E1010 (manufactured by Nisshin Chemical Industry Co., | 1 g |
| Ltd.) | |
| Ion-exchanged water | 64 g |

(Treatment Liquid 6)

A treatment liquid 6 was prepared by mixing the following materials.

| | |
|---|---|
| Malonic acid (aggregating agent) | 25 g |
| Diethylene glycol monobutyl ether | 30 g |
| NEWPOL P-62 (manufactured by Sanyo Chemical Industries, | 5 g |
| Ltd.) | |
| Ion-exchanged water | 29 g |
| OLFINE E1010 (manufactured by Nisshin Chemical Industry Co., | 1 g |
| Ltd.) | |

(Treatment Liquid 7)

A treatment liquid 7 was prepared by mixing the following materials.

| | |
|---|---|
| Malonic acid (aggregating agent) | 25 g |
| Triethylene glycol monomethyl ether | 15 g |
| Glycerin | 5 g |
| Ion-exchanged water | 54 g |
| OLFINE E1010 (manufactured by Nisshin Chemical Industry Co., | 1 g |
| Ltd.) | |

(Treatment Liquid 8)

A treatment liquid 8 was prepared by mixing the following materials.

| | |
|---|---|
| Malonic acid (aggregating agent) | 25 g |
| Ion-exchanged water | 74 g |
| OLFINE E1010 (manufactured by Nisshin Chemical Industry Co., | 1 g |
| Ltd.) | |

(Treatment Liquid 9)

A treatment liquid 9 was prepared by mixing the following materials.

| | |
|---|---|
| Malonic acid (aggregating agent) | 25 g |
| Glycerin | 20 g |
| Ion-exchanged water | 54 g |
| OLFINE E1010 (manufactured by Nisshin Chemical Industry Co., | 1 g |
| Ltd.) | |

(Treatment Liquid 10)

A treatment liquid 10 was prepared by mixing the following materials.

| | |
|---|---|
| Malonic acid (aggregating agent) | 25 g |
| Triethylene glycol | 20 g |
| Ion-exchanged water | 54 g |
| OLFINE E1010 (manufactured by Nisshin Chemical Industry Co., | 1 g |
| Ltd.) | |

(Treatment Liquid 11)

A treatment liquid 11 was prepared by mixing the following materials.

| | |
|---|---|
| Malonic acid (aggregating agent) | 25 g |
| Diethylene glycol monoethyl ether | 20 g |
| Ion-exchanged water | 54 g |
| OLFINE E1010 (manufactured by Nisshin Chemical Industry Co., | 1 g |
| Ltd.) | |

(Treatment Liquid 12)

A treatment liquid 12 was prepared by mixing the following materials.

| | |
|---|---|
| Malonic acid (aggregating agent) | 25 g |
| Diethylene glycol | 20 g |
| Ion-exchanged water | 54 g |
| OLFINE E1010 (manufactured by Nisshin Chemical Industry Co., | 1 g |
| Ltd.) | |

(Treatment Liquid 13)

A treatment liquid 13 was prepared by mixing the following materials.

| | |
|---|---|
| Malonic acid (aggregating agent) | 25 g |
| Triethylene glycol monobutyl ether | 12 g |
| Glycerin | 8 g |
| Ion-exchanged water | 54 g |
| OLFINE E1010 (manufactured by Nisshin Chemical Industry Co., | 1 g |
| Ltd.) | |

(Treatment Liquid 14)

A treatment liquid 14 was prepared by mixing the following materials.

| | |
|---|---|
| Malonic acid (aggregating agent) | 25 g |
| Tetraethylene glycol | 20 g |
| Ion-exchanged water | 54 g |
| OLFINE E1010 (manufactured by Nisshin Chemical Industry Co., | 1 g |
| Ltd.) | |

For the aqueous treatment liquid prepared, the viscosity at 20° C. was measured using a viscometer (model name: TV-22, manufactured by Toki Sangyo Co., Ltd.). The results are presented in Table 1.

<Image Recording>

TOKUBISHI ART (manufactured by Mitsubishi Paper Mills, Ltd., basis weight 104.7 g/m²), OK TOPCOAT+ (manufactured by Oji Paper Co., Ltd., basis weight 104.7 g/m²), and RECYCLECOAT T-6 (manufactured by Japan Paper Group, Inc., basis weight 98 g/m²), which are coated papers, were used as recording media. These papers were used in combination with treatment liquids as shown in the following Table 1, and images were formed under the following image recording conditions.

Furthermore, Table 1 also indicates the Ka (value until the inflection point is reached) with respect to water, which is obtained by measuring the liquid absorption according to the Bristow method in each of the recording media (coated papers).

—Treatment Liquid Supplying Step—

First, the aqueous treatment liquid was coated over the entire surface of the recording medium by means of a roll coater with an anilox roller by which the coating amount was controlled, such that the amount the aqueous treatment liquid coated on the recording medium was 1.2 ml/m² (0.30 g/m² in terms of the amount of the fixing agent coated). However, in Example 8, the aqueous treatment liquid was coated such that the coating amount was 0.9 ml/m² (0.23 g/m in terms of the coating amount of the fixing agent).

—Treatment Liquid Drying Step—

Subsequently, the recording media onto which the treatment liquid was supplied was dried under the following conditions.

Air speed: 15 m/s

Temperature: The recording medium was heated with a contact type plate heater from the opposite surface of the recording surface such that the surface temperature of the recording medium became 60° C.

Range of air blowing: 450 mm (drying time 0.9 seconds)

—Ink Supplying Step—

The cyan pigment ink C, magenta pigment ink M, yellow pigment ink Y and black pigment ink K obtained as described above were used as aqueous inks, and four color single pass image recording was carried out under the following conditions. A line image was recorded by ejecting lines of 1-dot width, lines of 2-dot width and lines of 4-dot width at 1200 dpi in the main scanning direction by single pass, and a solid image was recorded by ejecting an ink over the entire surface of a sample prepared by cutting a recording medium to A5 size.

An aqueous ink was supplied under the following conditions onto the recording medium onto which an aqueous treatment liquid had been supplied.

Head: Piezo full line heads of 1,200 dpi/20 inch width were arranged for 4 colors. Amount of ejected liquid droplets: Outputs were made at an amount of ink droplet of 3.5 pL.

Operating frequency: 30 kHz (conveyance speed for the recording medium 635 mm/sec)

Subsequently, the recording medium onto which ink was supplied was dried under the following conditions.

—Drying Conditions for Ink (Air Blowing Conditions)—

Air speed: 15 m/s

Temperature: The recording medium was heated with a contact type plate heater from the opposite surface of the recording surface such that the surface temperature of the recording medium became 60° C.

Range of air blowing: 640 mm (drying time 1 second)

Subsequently, a heating treatment (heating and fixing treatment) was carried out under the following conditions. However, in Example 9, the heating treatment was not carried out.

—Heating Treatment—

Silicone rubber roller (hardness 70°, nip width 4 mm)

Roller temperature: 75° C.

Pressure: 0.5 MPa

<Evaluation Method>

—Curling—

An aqueous ink (cyan pigment ink C) was dropped respectively on samples (recording media) prepared by cutting paper to a size of 50 mm—5 mm in the machine direction (MD) and the cross direction (CD), respectively, according to the image recording conditions such that an amount of the ink was 10 g/m², and thereby solid images were formed. After forming the images, the degree of curl after 12 hours at 23° C. and 50% RH was measured according to the curl curvature measuring method that is stipulated in JAPAN TAPPI Paper and Pulp Test Method No. 15-2:2000, the disclosure of which is incorporated by reference herein, and thereby the degree of curl was evaluated according to the following evaluation criteria. The evaluation results are shown in Table 1.

Evaluation Criteria

A: The degree of curl was less than 10.

B: The degree of curl was 10 or more and less than 20.

C: The degree of curl was 20 or more and less than 30.

D: The degree of curl was 30 or more.

—Dot Stability—

A cyan dot of cyan (C) alone, and a cyan dot on a magenta (M) solid image were respectively formed, and the dot diameter of the cyan dots was measured using a dot analyzer (trade name: DA-6000, manufactured by Oji Scientific Instruments, Inc.). The dot diameter was measured at 50 points, and the average value was used.

The difference between the cyan dot diameter on a magenta (M) solid image and the cyan dot diameter of cyan (C) alone was calculated, and was evaluated according to the following evaluation criteria.

Evaluation Criteria

A: The difference in the dot diameter was less than 2.0 μm.

B: The difference in the dot diameter was 2.0 μm or more and less than 3.0 μm.

C: The difference in the dot diameter was 3.0 μm or more and less than 5.0 μm.

D: The difference in the dot diameter was 5.0 μm or more.

Abrasion Resistance

In the recording medium onto which an ink composition was supplied, immediately after printing, a solid part of 2 cm square was rubbed with a finger, and the extent of the ink transferred to blank parts was observed by visual inspection. The evaluation criteria for abrasion resistance are as follows. The evaluation results are shown in Table 1.

Evaluation Criteria

A: There was no transfer of ink at all.

B: Transfer of ink was nearly unnoticeable.

C: Transfer of ink was fairly visible.

D: Significant transfer of ink was observed.

TABLE 1

| | | | | | | | | Content |
|---|---|---|---|---|---|---|---|---|
| | | | | | | | | of water- |
| | | | | | Water- | | | soluble |
| | | Basis | | Treatment | soluble | | Boiling | organic |
| | Coated | weight | Ka value | liquid | organic | SP | point | solvent |
| | paper | (*1) | (*2) | (*3) | solvent | value | (° C.) | (%) |
| Example 1 | TOKUBISHI | 104.7 | 0.12 | TL 1 | DEGmBE | 21.5 | 231 | 20 |
| | ART | | | | | | | |
| Example 2 | TOKUBISHI | 104.7 | 0.12 | TL 2 | TEGmME | 22.1 | 245 | 20 |
| | ART | | | | | | | |
| Example 3 | TOKUBISHI | 104.7 | 0.12 | TL 3 | TEGmBE | 21.1 | 278 | 20 |
| | ART | | | | | | | |
| Example 4 | TOKUBISHI | 104.7 | 0.12 | TL 4 | DPG | 27.2 | 232 | 20 |
| | ART | | | | | | | |
| Example 5 | TOKUBISHI | 104.7 | 0.12 | TL 5 | DEGmBE | 21.5 | 231 | 20 |
| | ART | | | | | | | |
| Example 6 | TOKUBISHI | 104.7 | 0.12 | TL 6 | DEGmBE | 21.5 | 231 | 30 |
| | ART | | | | PE-62 | 18.7 | >280 | 5 |
| Example 7 | TOKUBISHI | 104.7 | 0.12 | TL 7 | TEGmME | 22.1 | 245 | 15 |
| | ART | | | | Glycerin | 33.5 | 290 | 5 |
| Example 8 | TOKUBISHI | 104.7 | 0.12 | TL 1 | DEGmBE | 21.5 | 231 | 20 |
| | ART | | | | | | | |
| Example 9 | TOKUBISHI | 104.7 | 0.12 | TL 1 | DEGmBE | 21.5 | 231 | 20 |
| | ART | | | | | | | |
| Example | OK | 104.7 | 0.18 | TL 1 | DEGmBE | 21.5 | 231 | 20 |
| 10 | TOPCOAT + | | | | | | | |
| Example | OK | 104.7 | 0.18 | TL 2 | TEGmME | 22.1 | 245 | 20 |
| 11 | TOPCOAT + | | | | | | | |
| Example | OK | 104.7 | 0.18 | TL 3 | TEGmBE | 21.1 | 278 | 20 |
| 12 | TOPCOAT + | | | | | | | |
| Example | RECYCLE | 98 | 0.29 | TL 1 | DEGmBE | 21.5 | 231 | 20 |
| 13 | COAT T-6 | | | | | | | |
| Example | RECYCLE | 98 | 0.29 | TL 2 | TEGmME | 22.1 | 245 | 20 |
| 14 | COAT T-6 | | | | | | | |
| Example | RECYCLE | 98 | 0.29 | TL 3 | TEGmBE | 21.1 | 278 | 20 |
| 15 | COAT T-6 | | | | | | | |
| Comparative | TOKUBISHI | 104.7 | 0.12 | TL 8 | — | — | — | — |
| Example 1 | ART | | | | | | | |
| Comparative | TOKUBISHI | 104.7 | 0.12 | TL 9 | Glycerin | 33.5 | 290 | 20 |
| Example 2 | ART | | | | | | | |
| Comparative | TOKUBISHI | 104.7 | 0.12 | TL 10 | TEG | 27.8 | 287 | 20 |
| Example 3 | ART | | | | | | | |
| Comparative | TOKUBISHI | 104.7 | 0.12 | TL 11 | DEGmEE | 22.4 | 202 | 20 |
| Example 4 | ART | | | | | | | |
| Comparative | TOKUBISHI | 104.7 | 0.12 | TL 12 | DEG | 30.6 | 245 | 20 |
| Example 5 | ART | | | | | | | |
| Comparative | TOKUBISHI | 104.7 | 0.12 | TL 13 | Glycerin | 33.5 | 290 | 8 |
| Example 6 | ART | | | | TEGmBE | 21.1 | 278 | 12 |
| Comparative | TOKUBISHI | 104.7 | 0.12 | TL 14 | Tetra- | 26.1 | 327 | 20 |
| Example 7 | ART | | | | ethylene | | | |
| | | | | | glycol | | | |
| Comparative | OK TOPCOT + | 104.7 | 0.18 | TL 9 | Glycerin | 33.5 | 290 | 20 |
| Example 8 | | | | | | | | |
| Comparative | RECYCLE | 98 | 0.29 | TL 9 | Glycerin | 33.5 | 290 | 20 |
| Example 9 | COAT T-6 | | | | | | | |

| | Content of | | | | | |
|---|---|---|---|---|---|---|
| | specific | | | | | |
| | water- | | | | | |
| | soluble | | | | | |
| | organic | Viscosity | | Dot | Abrasion | |
| | solvent (%) | (mPa · s) | Curling | stability | resistance | Remarks |
| Example 1 | 100 | 3.1 | A | A | A | |
| Example 2 | 100 | 2.8 | A | A | A | |
| Example 3 | 100 | 3.0 | A | A | B | |
| Example 4 | 100 | 2.7 | B | B | A | |
| Example 5 | 100 | 2.8 | A | B | B | |
| Example 6 | 86 | 8.1 | B | B | B | |
| Example 7 | 75 | 3.0 | B | A | B | |
| Example 8 | 100 | 3.1 | A | B | A | fixing agent |
| | | | | | | coating |
| | | | | | | amount |
| | | | | | | 0.23 g/m² |
| Example 9 | 100 | 3.1 | B | A | B | no heating |
| | | | | | | step |
| Example | 100 | 2.9 | A | A | A | |
| 10 | | | | | | |
| Example | 100 | 2.8 | A | A | A | |
| 11 | | | | | | |
| Example | 100 | 3.0 | A | A | B | |
| 12 | | | | | | |
| Example | 100 | 2.9 | A | A | A | |
| 13 | | | | | | |
| Example | 100 | 2.8 | A | A | A | |
| 14 | | | | | | |
| Example | 100 | 3.0 | A | A | B | |
| 15 | | | | | | |
| Comparative | — | 1.6 | D | D | C | |
| Example 1 | | | | | | |
| Comparative | — | 3.2 | D | C | C | |
| Example 2 | | | | | | |
| Comparative | — | 2.7 | D | C | C | |
| Example 3 | | | | | | |
| Comparative | — | 2.9 | B | C | A | |
| Example 4 | | | | | | |
| Comparative | — | 2.7 | D | C | B | |
| Example 5 | | | | | | |
| Comparative | 60 | 3.1 | D | B | C | |
| Example 6 | | | | | | |
| Comparative | — | 3.0 | B | B | D | |
| Example 7 | | | | | | |
| Comparative | — | 3.2 | D | C | C | |
| Example 8 | | | | | | |
| Comparative | — | 3.2 | D | C | B | |
| Example 9 | | | | | | |

(*1) unit: g/m²
(*2) unit: ml · m⁻² · msec^{-1/2}
(*3) TL1 to TL8 indicates treatment liquid 1 to treatment liquid 8 respectively.

The abbreviations for the water-soluble organic solvents in Table 1 are as follows.

DEGmBE: Diethylene glycol monobutyl ether

TEGmME: Triethylene glycol monomethyl ether

TEGmBE: Triethylene glycol monobutyl ether

DPG: Dipropylene glycol

TEG: Triethylene glycol

DEG: Diethylene glycol

Furthermore, the “content of specific water-soluble organic solvent” in Table 1 means the content relative to the total amount of water-soluble organic solvents.

From Table 1, it was found that according to the ink-jet recording method of the invention, even when using a coated paper having a low solvent penetration speed, it is possible to form images in which the obtained images have good abrasion resistance, fluctuation in the diameter of a dot of a second color is small, and the occurrence of curling is suppressed.

According to the invention, an ink-jet recording method in which even in the case of using a coated paper having a low solvent penetration speed, it is possible to provide a ink-jet recording method in which the obtained image has good abrasion resistance, the fluctuation in the diameter of a dot of second color is small, and the occurrence of curling is suppressed.

Hereinafter exemplary embodiments of the present invention will be listed. However, the present invention is not limited to the following exemplary embodiments.

<1> An ink-jet recording method, comprising:

recording an image by ejecting, using an ink-jet method, an aqueous ink containing a colorant, resin particles, a water-soluble organic solvent and water onto a coated paper having a Ka value with respect to water, which is obtained by measuring liquid absorbability according to the Bristow method, of from 0.1 ml·m⁻²·msec^{-1/2} to 0.3 ml·m⁻² msec^{-1/2}; and

supplying, onto the coated paper, an aqueous treatment liquid containing a fixing agent for fixing the components contained in the aqueous ink, and a water-soluble organic solvent which is contained in an amount of 70% by mass or more relative to the total amount of water-soluble organic solvents contained in the aqueous treatment liquid, and has an SP value of 27.5 or less and a boiling point at 101.3 kPa of from 230° C. to 280° C.

<2> The ink-jet recording method of <1>, wherein the total amount of the water-soluble organic solvents contained in the aqueous treatment liquid is 30% by mass or less relative to the aqueous treatment liquid.

<3> The ink-jet recording method of <1> or <2>, wherein in the recording of an image, the aqueous ink is ejected onto the coated paper onto which the aqueous treatment liquid has been supplied in the supplying of an aqueous treatment liquid.

<4> The ink-jet recording method of any one of <1> to 3>, wherein the recording of an image further comprises heating.

<5> The ink-jet recording method of any one of <1> to <4>, wherein the viscosity of the aqueous treatment liquid is from 2 mPa·s to 8 mPa·s.

<6> The ink-jet recording method of anyone of <1> to <5>, wherein in the supplying of an aqueous treatment liquid, the fixing agent is supplied in an amount of 0.25 g/m² or more.

<7> The ink-jet recording method of any one of <1> to <6>, wherein the fixing agent is a di- or higher valent acidic substance.

<8> The ink-jet recording method of any one of <1> to <8>, wherein the water-soluble organic solvent which is contained in an amount of 70% by mass or more relative to the total amount of the water-soluble organic solvents contained in the aqueous treatment liquid, and has an SP value of 27.5 or less and a boiling point at 101.3 kPa of from 230° C. to 280° C., has a vapor pressure at 20° C. of less than 0.01 kPa.

<9> The ink-jet recording method of any one of <1> to <8>, wherein the resin particles are acrylic resin particles.

<10> The ink-jet recording method of any one of <1> to <9>, wherein the resin particles are self-dispersing polymer particles.

<11> The ink-jet recording method of <10>, wherein the self-dispersing polymer particles comprise a water-insoluble polymer including a hydrophilic constituent unit and a constituent unit derived from an aromatic group-containing monomer.

All publications, patent applications, and technical standards mentioned in this specification are herein incorporated by reference to the same extent as if each individual publication, patent application, or technical standard was specifically and individually indicated to be incorporated by reference.

What is claimed is:

1. An ink-jet recording method, comprising:
recording an image by ejecting, using an ink-jet method, an aqueous ink containing a colorant, resin particles, a water-soluble organic solvent and water onto a coated paper having a Ka value with respect to water, which is obtained by measuring liquid absorbability according to the Bristow method, of from 0.1 ml·m⁻²·msec^{-1/2} to 0.3 ml·m⁻²·msec^{-1/2}; and
supplying, onto the coated paper, an aqueous treatment liquid containing a fixing agent for fixing the components contained in the aqueous ink, and a water-soluble organic solvent which is contained in an amount of 70% by mass or more relative to the total amount of water-soluble organic solvents contained in the aqueous treatment liquid, and has an SP value of 27.5 or less and a boiling point at 101.3 kPa of from 230° C. to 280° C.

2. The ink-jet recording method of claim 1, wherein the total amount of the water-soluble organic solvents contained in the aqueous treatment liquid is 30% by mass or less relative to the aqueous treatment liquid.

3. The ink-jet recording method of claim 1, wherein in the recording of an image, the aqueous ink is ejected onto the coated paper onto which the aqueous treatment liquid has been supplied in the supplying of an aqueous treatment liquid.

4. The ink-jet recording method of claim 1, wherein the recording of an image further comprises heating.

5. The ink-jet recording method of claim 1, wherein the viscosity of the aqueous treatment liquid is from 2 mPa·s to 8 mPa·s.

6. The ink-jet recording method of claim 1, wherein in the supplying of an aqueous treatment liquid, the fixing agent is supplied in an amount of 0.25 g/m² or more.

7. The ink-jet recording method of claim 1, wherein the fixing agent is a di- or higher valent acidic substance.

8. The ink-jet recording method of claim 1, wherein the water-soluble organic solvent which is contained in an amount of 70% by mass or more relative to the total amount of the water-soluble organic solvents contained in the aqueous treatment liquid, and has an SP value of 27.5 or less and a boiling point at 101.3 kPa of from 230° C. to 280° C., has a vapor pressure at 20° C. of less than 0.01 kPa.

9. The ink-jet recording method of claim 1, wherein the resin particles are acrylic resin particles.

10. The ink-jet recording method of claim 1, wherein the resin particles are self-dispersing polymer particles.

11. The ink-jet recording method of claim 10, wherein the self-dispersing polymer particles comprise a water-insoluble polymer including a hydrophilic constituent unit and a constituent unit derived from an aromatic group-containing monomer.
